(19) United States
(12) Patent Application Publication
(10) Pub. No.: US 2011/0037863 A1
(43) Pub. Date: Feb. 17, 2011

(54) IMAGING DEVICE

(75) Inventors: Norihito Mihota, Saitama (JP); Hirofumi Kawamura, Chiba (JP); Youtarou Sanada, Tokyo (JP); Ryuichi Yasuhara, Osaka (JP); Katsuhiko Ueno, Tokyo (JP)

Correspondence Address: SNR DENTON US LLP, P.O. BOX 061080, CHICAGO, IL, 60606-1080, US

(73) Assignee: SONY CORPORATION, Tokyo (JP)

(21) Appl. No.: 12/850,178

(22) Filed: Aug. 4, 2010

(30) Foreign Application Priority Data
Aug. 13, 2009 (JP) 2009-187710

(51) Int. Cl. H04N 5/228; G03B 17/00; H01P 3/12; H02J 17/00

(52) U.S. Cl. 348/208.99; 396/55; 333/239; 307/154; 348/E09.002

(57) ABSTRACT

Disclosed herein is an imaging device including: a first substrate having a first communication device; a second substrate having a solid-state imaging device and second communication device to exchange signals with the first substrate; a shake correction section adapted to detect the shake of an enclosure and correct the shake based on the detection result by moving the first substrate in the plane vertical to the optical path; and a millimeter wave signal transmission line that permits transmission of information in the millimeter wave band between the first and second communication devices, wherein a signal to be transmitted between the first and second communication devices is converted into a millimeter wave signal first before being transmitted via the millimeter wave signal transmission line.

### BACKGROUND OF THE INVENTION

1. Field of the Invention

The present invention relates to an imaging device, and more particularly, to an imaging device capable of shake correction by moving its solid-state imaging device (imaging element).

2. Description of the Related Art

In an imaging device (e.g., digital camera), the captured image is disturbed by the hand shake of the operator or vibration of the operator and imaging device together. For example, a single reflex digital camera reflects the image passing through the lens with a main mirror in the shooting preparation stage. The image is formed on a focal plate provided in a pentaprism section at the top of the camera. The user verifies whether the image is in focus. In the next shooting stage, the main mirror retracts from the optical path, allowing the image passing through the lens to be formed on the solid-state imaging device and recorded. That is, the user is unable to directly verify whether the image is in focus on the solid-state imaging device in the shooting stage. As a result, the image is shot out of focus should the position of the solid-state imaging device along the optical axis be unstable.

As a shake correction mechanism adapted to suppress such a disturbance in the shot image (commonly referred to as a hand shake correction mechanism), therefore, a mechanism is known that is adapted, for example, to correct the shake by moving the solid-state imaging device (refer, for example, to Japanese Patent Laid-Open Nos. 2003-110919 and 2006-352418, hereinafter referred to as Patent Documents 1 and 2).

In the shake correction mechanism disclosed in Patent Document 1, a substrate having the solid-state imaging device (referred to as the imaging substrate) and a substrate having control circuitry (referred to as the main substrate) are connected by cables or flexible printed wiring board. It is known that LVDS (Low Voltage Differential Signaling) is, for example, used for signal transmission.

As a result of transmission of increased volumes of data at higher speeds in recent years, however, LVDS has reached its limits in terms of increased impact of signal distortion and unwanted radiation caused, for example, by increased power consumption and reflection.

A possible solution to the problem of increased volumes of target data and faster transmission speeds would be to increase the number of wires and parallel the signals so as to reduce the data transmission volume and speed for each signal line. However, this remedy leads to an increased number of I/O terminals. As a result, it will be necessary to use more complex printed circuit boards and cabling and enlarge the semiconductor chip size. Moreover, routing high-speed and large-volume data with wires gives rise to electromagnetic interference.

The problems associated with LVDS and increased number of wires arise from transmission of signals over electrical wires.

In contrast, Patent Document 2 proposes arrangements adapted to minimize the number of cables by wirelessly handling part of the transmission and reception of signals that take place between the imaging substrate and main substrate. In Patent Document 2, for example, the digital image signals are transmitted and received wirelessly between the imaging substrate and main substrate. Patent Document 2 proposes two arrangements as wireless communication schemes, one adapted to achieve communication between a light emitting section and light receiving section via light (claims 3 to 5: optical communication scheme) and another adapted to achieve communication between a transmission section and reception section via electromagnetic wave (claim 6: scheme adapted to modulate electromagnetic wave).

As for communication via light, it has been proposed to apply the IrDA standard. The IrDA standard has been defined by IrDA. This standard uses a light-emitting element such as infrared LED and semiconductor laser. As for communication via electromagnetic wave, it has been proposed to apply, for example, IEEE802.11a, 11b and 11g or a scheme obtained by simplifying these standards. The IEEE802.11a, 11b and 11g standards use the 2.4 GHz and 5 GHz bands.

On the other hand, Patent Document 2 proposes arrangements adapted to address the travel of the imaging substrate. As for the optical communication scheme, the document proposes the communication during the travel of the imaging substrate, for example, by selecting a light-receiving element with a wide light reception range and providing a plurality of light-receiving elements at positions opposed to the travel range of the transmission section (paragraph 53). Further, the document proposes the travel of the imaging substrate to the position where the light emitting section and light receiving section are opposed to each other after the shake correction (paragraph 65). Still further, the document proposes conducting communication after the travel and fixation of the imaging substrate rather than conducting communication during the travel so as to ensure reliable communication (claim 5).

In the scheme adapted to modulate electromagnetic wave, the reception section and transmission section can be disposed in such a manner that they are not opposed to each other. Therefore, this basically permits communication during travel. In order to reduce the impact of electromagnetic noise of the drive system adapted to correct the shake, however, it is proposed to conduct communication after stopping the shake correction operation.

### SUMMARY OF THE INVENTION

The arrangements disclosed in Patent Document 2 are designed to transmit signals wirelessly rather than via electrical wires. These arrangements seem to solve the problems arising from the transmission of signals via electrical wires.

However, the arrangements disclosed in Patent Document 2 have, for example, the following drawbacks.

1) The scheme using infrared LED is narrow in band, making it unfit for high-speed communication. On the other hand, although infrared semiconductor laser is fast, high positioning accuracy is required. Moreover, these schemes result in high cost because an infrared LED or infrared semiconductor laser cannot be integrated into a single chip together with silicon-based semiconductor integrated circuitry.

2) If the 2.4 GHz or 5 GHz band is used, the carrier frequency is low, making the scheme unfit for high-speed communication as for transmitting video signals. There are also size problems such as increased size of the antenna. Further, the frequency used for transmission is close to that used for processing other baseband signals, making interference likely. Still further, if the 2.4 GHz or 5 GHz band is used, electromagnetic noise of the drive system in the equipment is likely to produce adverse impact. As a result, a countermeasure for such electromagnetic noise is required.

3) In the optical communication scheme and scheme adapted to modulate electromagnetic wave, if communication is initiated after the solid-state imaging device is fixed to a predetermined position, it is necessary to control this operation, thus resulting in time constraints.

4) Power and high-speed control signals are treated as signals that cannot be transmitted by wireless communication. Therefore, these signals are connected by cables made of a long and narrow elastically deformable material. Although this reduces the number of electrical wires, it is necessary to adhere to the connections by using cables and connectors.

It should be noted that the problem with Patent Document 2 shown here is merely an example. We add that there are other problems as described later.

As described above, if the arrangements disclosed in Patent Document 2 are applied to an imaging device capable of shake correction by moving its solid-state imaging device, drawbacks remain to be solved.

It is desirable to provide an imaging device, capable of shake correction by moving its solid-state imaging device, with a new arrangement adapted to permit transmission of signals (not necessarily all signals) between a substrate having the solid-state imaging device and another substrate without using electrical wires while at the same time resolving at least one of the problems of the arrangements disclosed in Patent Document 2.

An imaging device according to a first embodiment of the present invention includes first and second substrates. The first substrate has a first communication device. The second substrate has a solid-state imaging device and second communication device to exchange signals with the first substrate. The imaging device also includes a shake correction section and millimeter wave signal transmission line. The shake correction section detects the shake of the enclosure and corrects shake based on the detection result by moving the first substrate in the plane vertical to the optical path. The millimeter wave signal transmission line permits transmission of information in the millimeter wave band between the first and second communication devices.

The first communication device (first millimeter wave transmission device) and second communication device (second millimeter wave transmission device) make up a wireless transmission device (system) in the imaging device. Then, a signal to be transmitted between the first and second communication devices, arranged at a relatively close distance from each other, is converted into a millimeter wave signal first before being transmitted via a millimeter wave signal transmission line. The term “wireless transmission” in the present invention refers to transmission of a target signal by using millimeter wave rather than electrical wires.

The term “relatively close distance” refers to a distance shorter than that between communication devices used for broadcasting and common wireless communication. This distance need only be a distance that permits the transmission range to be substantially identified as a closed space. In the present example, millimeter wave signal transmission between the second substrate having the solid-state imaging device and the other substrate (first substrate) is applicable.

In the communication devices arranged with the millimeter wave signal transmission line provided therebetween, a transmission section and reception section are provided as a pair. Signal transmission between the two communication devices may be unidirectional or bidirectional. For example, when the first communication device serves as a transmitting side and the second communication device as a receiving side, the transmission section is provided in the first communication device, and the reception section in the second communication device. When the second communication device serves as a transmitting side and the first communication device as a receiving side, the transmission section is provided in the second communication device, and the reception section in the first communication device.

For example, if only the imaging signal obtained by the solid-state imaging device is transmitted, it is only necessary to use the second substrate as a transmitting side and the first substrate as a receiving side. If only the signals adapted to control the solid-state imaging device (e.g., master clock signal, control signals and synchronizing signal) are transmitted, it is only necessary to use the first substrate as a transmitting side and the second substrate as a receiving side.

The transmission section includes a transmitting-side signal generating section and a transmitting-side signal coupling section. The transmitting-side signal generating section generates a millimeter wave signal by processing a signal to be transmitted (signal conversion section adapted to convert an electric signal to be transmitted into a millimeter wave signal). The transmitting-side signal coupling section couples the millimeter wave signal, generated by the transmitting-side signal generating section, to the transmission line adapted to transmit the millimeter wave signal (millimeter wave signal transmission line). The transmitting-side signal generating section should preferably be integral with a function section adapted to generate a signal to be transmitted.

For example, the transmitting-side signal generating section has a modulation circuit to modulate the signal to be transmitted. The transmitting-side signal generating section generates a millimeter wave signal by frequency-converting a modulated signal modulated by the modulation circuit. On principle, it is also possible to convert the signal to be transmitted directly into a millimeter wave signal. The transmitting-side signal coupling section supplies the millimeter wave signal, generated by the transmitting-side signal generating section, to the millimeter wave signal transmission line.

On the other hand, the reception section includes a receiving-side signal coupling section and a receiving-side signal generating section. The receiving-side signal coupling section receives the millimeter wave signal transmitted via the millimeter wave signal transmission line. The receiving-side signal generating section (signal conversion section adapted to convert the millimeter wave signal into an electric signal to be transmitted) generates a common electric signal (signal to be transmitted) by processing the millimeter wave signal (input signal) received by the receiving-side signal coupling section. The receiving-side signal generating section should preferably be integral with a function section adapted to receive a signal to be transmitted. For example, the receiving-side signal generating section has a demodulation circuit and generates an output signal by frequency-converting the millimeter wave signal. Then, the same section generates a signal to be transmitted as the demodulation circuit demodulates the output signal. On principle, it is also possible to convert the millimeter wave signal directly into a signal to be transmitted.

That is, in order to provide a signal interface between the first and second substrates, the signal to be transmitted is transmitted by using a millimeter wave signal in a contactless or cableless manner. At least signal transmission (particularly, transmission of an imaging signal and high-speed master clock signal) should preferably be achieved by using a millimeter wave signal. To sum up, the signal transmission between the substrates achieved by using electrical wires is performed by using a millimeter wave signal. Achieving the signal transmission by using a millimeter wave band paves the way for high-speed signal transmission with a data rate of the order of Gbps, making it possible to readily restrict the area the millimeter wave signal can cover (the reason for this will be described in the embodiments). Further, the effects arising from the property thereof can be obtained.

Those signals that do not require high-speed transmission such as control signals and synchronizing signal adapted to control the solid-state imaging device may also be transmitted by means of a communication interface using a millimeter wave signal in a contactless or cableless manner.

That is, the imaging device capable of shake correction according to an embodiment of the present invention uses millimeter wave signal transmission to transmit a variety of signals between the second substrate having the solid-state imaging device and the first substrate having image processing, signal generating and other sections. Among the signals to be transmitted between the two substrates are an imaging signal and signals used to control the solid-state imaging device.

Power consumed by the second substrate should also preferably be transmitted wirelessly. Any of the electromagnetic induction, radio wave reception and resonance methods can be used for wireless power transmission. However, the resonance method (particularly, the method relying on the resonance of a magnetic field) should preferably be used.

Here, each of the signal coupling sections need only allow for millimeter wave signal transmission between the first and second communication devices via a millimeter wave signal transmission line. For example, each of the signal coupling sections may include an antenna structure (antenna coupling section). Alternative, each of the signal coupling sections may achieve coupling without including an antenna structure.

The “millimeter wave signal transmission line adapted to transmit a millimeter wave signal” may be air (so-called free space), but should preferably be structured to transmit a millimeter wave signal while trapping the signal in the transmission line. Actively taking advantage of this property makes it possible to determine, at will, the routing of the millimeter wave signal transmission line, for example, as in the case of electrical wires.

Among acceptable transmission lines having such a structure are that made of a dielectric material capable of millimeter wave signal transmission (referred to as a dielectric transmission line or millimeter wave dielectric-coated transmission line) and a hollow waveguide in which the transmission line is made up of and surrounded by a hollow shielding material adapted to suppress external radiation of the millimeter wave signal. The millimeter wave signal transmission line can be routed if the dielectric material or shielding material is flexible.

Incidentally, if air (so-called free space) is used, each of the signal coupling sections takes on an antenna structure. As a result, signals are transmitted in a space over a short distance thanks to the antenna structure. On the other hand, if a transmission line made of a dielectric material is used, each of the signal coupling sections may take on an antenna structure. However, this is not absolutely necessary.

An embodiment of the present invention permits transmission of signals between two substrates, i.e., an imaging substrate (second substrate) to be moved so as to achieve shake correction and another substrate (first substrate) without using electrical wires while at the same time resolving the problems of the arrangements disclosed in Patent Document 2. This embodiment enable building a unidirectional or bidirectional signal interface that is simple and inexpensive in configuration by using a millimeter wave signal for transmission between communication devices (i.e., substrates).

The use of a millimeter wave signal for signal transmission makes it possible to avoid the problems associated with the use of light and the problems associated with the modulation of the 2.4 GHz and 5 GHz band electromagnetic waves, thus resolving the problems with the arrangements disclosed in Patent Document 2.

For example, the use of a millimeter wave band prevents interference with nearby electrical wires, thus reducing the necessity of EMC countermeasures required when electrical wires (e.g., flexible printed wiring board) are used.

Further, the use of a millimeter wave band allows to use a higher data rate than when electrical wires (e.g., flexible printed wiring board) are used, thus making it possible to readily speed up an image signal as a result of higher definition and higher frame rate.

### BRIEF DESCRIPTION OF THE DRAWINGS

FIG. 1A is a diagram describing a signal interface of a wireless transmission system according to a first embodiment in terms of functional configuration;

FIGS. 1B to 1E are diagrams describing signal multiplexing in the wireless transmission system according to the first embodiment;

FIG. 2 is a diagram describing a wireless transmission system in a comparative example in terms of functional configuration;

FIG. 3 is a diagram describing a signal interface of a wireless transmission system according to a second embodiment in terms of functional configuration;

FIG. 4A is a diagram describing a signal interface of a wireless transmission system according to a third embodiment in terms of functional configuration;

FIGS. 4B to 4D are diagrams describing proper conditions for space division multiplexing;

FIG. 5 is a diagram describing a signal interface of a wireless transmission system according to a fourth embodiment in terms of functional configuration;

FIG. 6 is a diagram describing a signal interface of a wireless transmission system according to a fifth embodiment in terms of functional configuration;

FIGS. 7A and 7B are diagrams describing first examples of a modulation function section and demodulation function section;

FIGS. 8A to 8D are diagrams describing second examples of the modulation function section and its peripheral circuitry;

FIGS. 9A to 9D are diagrams describing second examples of the demodulation function section and its peripheral circuitry;

FIG. 10 is a diagram describing the phase relationship in injection locking;

FIGS. 11A to 11D are diagrams describing the relationship between providing multiple channels and injection locking;

FIGS. 12A to 12C are diagrams describing a comparative example of a millimeter wave transmission structure according to a present embodiment;

FIGS. 12D to 12U are diagrams describing a first example of the millimeter wave transmission structure according to the present embodiment; and

FIGS. 13A to 13L are diagrams describing a second example of the millimeter wave transmission structure according to the present embodiment.

### DETAILED DESCRIPTION OF THE PREFERRED EMBODIMENTS

A detailed description will be given below of the embodiments of the present invention with reference to the accompanying drawings. Each functional element will be distinguished between the different embodiments by assigning an uppercase letter such as “A,” “B,” “C” and so on as a reference numeral. Further, each functional element may be assigned reference numeral “@” for fragmentation of the element into parts and distinction therebetween. If a description is given without making any distinction, the above reference numerals will be omitted. The same is true for the drawings.

A description will be given in the following order:

1. Wireless transmission system: First embodiment (millimeter wave transmission of high-speed signal)
2. Wireless transmission system: Second embodiment (millimeter wave transmission of low-speed signal)
3. Wireless transmission system: Third embodiment (space division multiplexing)
4. Wireless transmission system: Fourth embodiment (second embodiment and wireless transmission of power)
5. Wireless transmission system: Fifth embodiment (third embodiment and wireless transmission of power)
6. Modulation and demodulation: First example
7. Modulation and demodulation: Second example
8. Relationship between providing multiple channels and injection locking
9. Millimeter wave transmission structure in imaging device: First example (single transmission channel)
10. Millimeter wave transmission structure in imaging device: First example (multiple transmission channels)

### <Wireless Transmission System: First Embodiment>

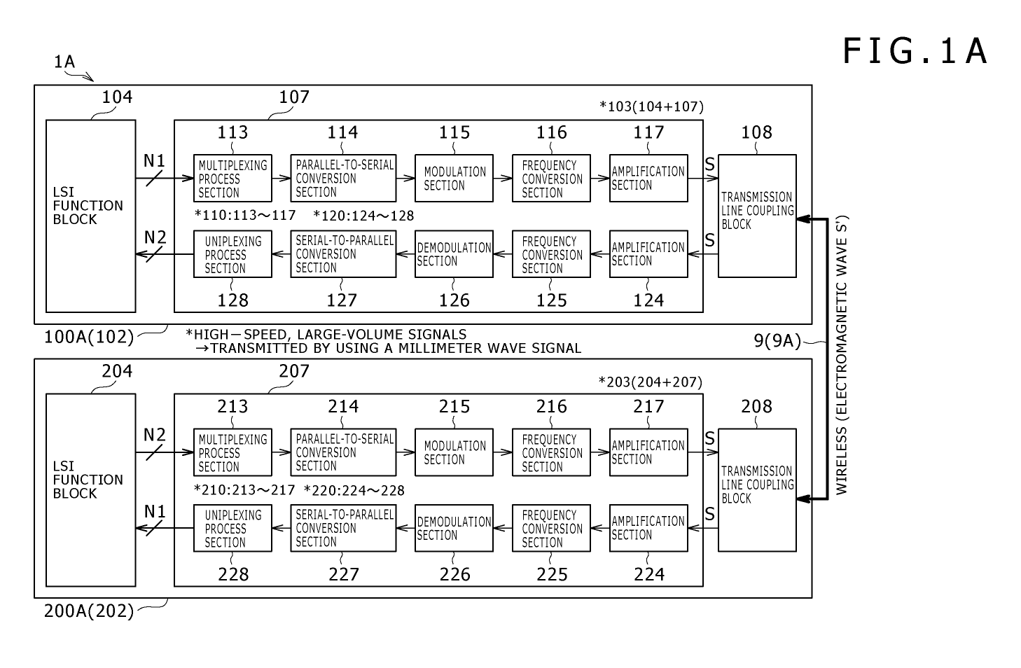

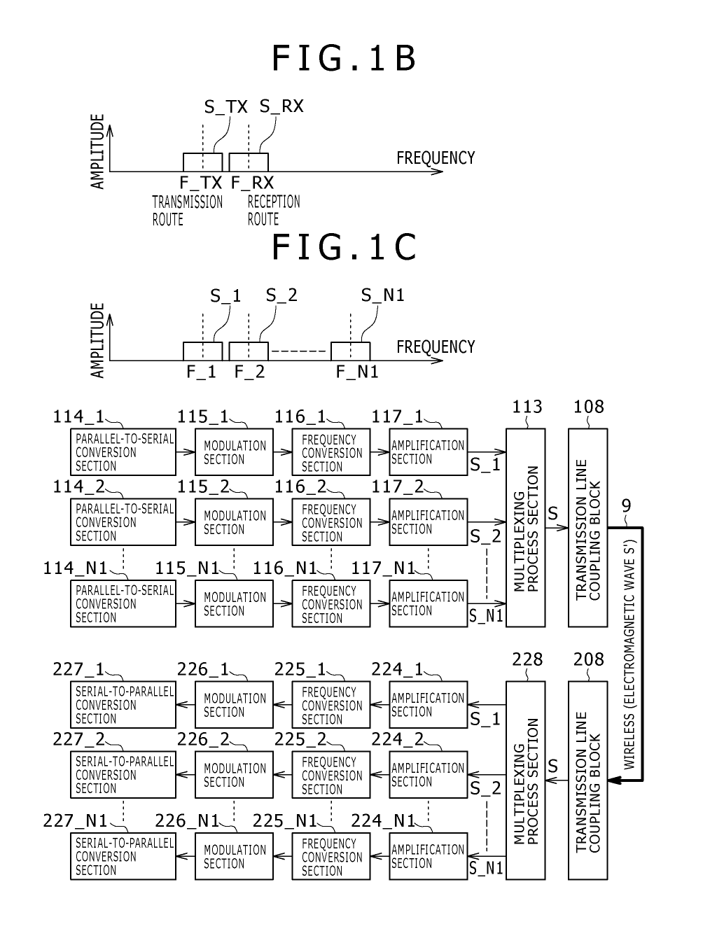

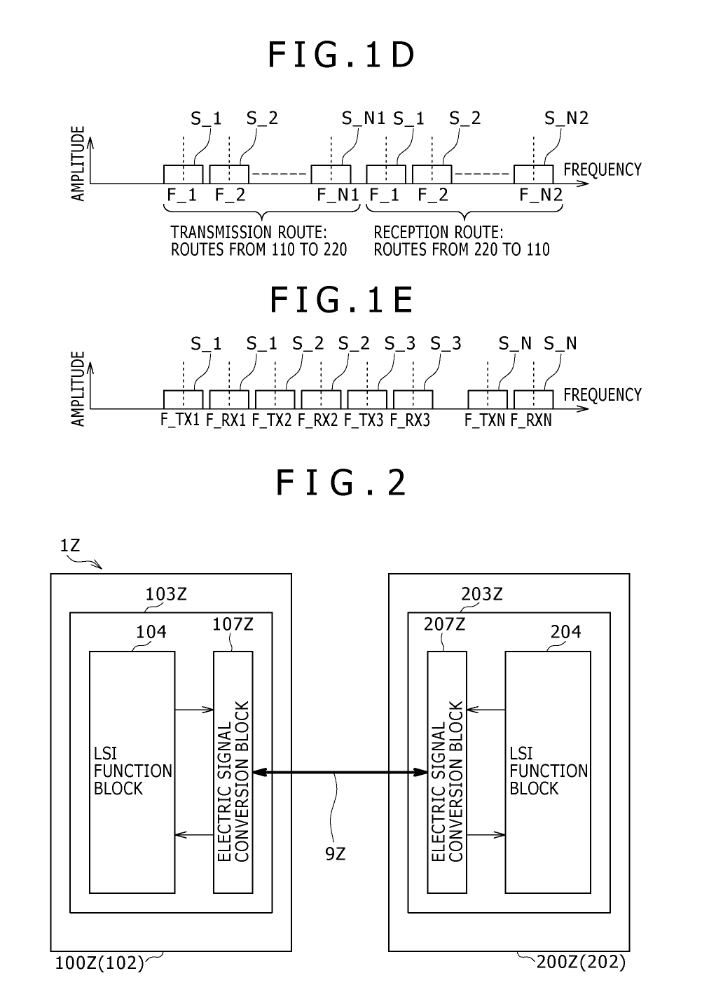

FIGS. 1A to 1E and FIG. 2 are diagrams describing the signal interfaces of the wireless transmission systems according to a first embodiment. Here, FIG. 1A is a diagram describing the signal interface of a wireless transmission system 1A according to the first embodiment in terms of functional configuration. FIGS. 1B to 1E are diagrams describing signal multiplexing in the wireless transmission system 1A. FIG. 2 is a diagram describing the signal interface of a wireless transmission system 1Z of a comparative example in terms of functional configuration.

### [Functional Configuration: First Embodiment]

As illustrated in FIG. 1A, the wireless transmission system 1A includes first and second communication devices 100A and 200A. The first communication device 100A is an example of first wireless equipment, and the second communication device 200A an example of second wireless equipment. The first and second communication devices 100A and 200A are coupled via a millimeter wave signal transmission line 9 for signal transmission in the millimeter wave band. The signal to be transmitted is transmitted after frequency-conversion into a millimeter wave band signal suited for wideband transmission.

As a combination of communication devices 100 and 200, we consider, in the present embodiment, examples of application to signal transmission between the imaging substrate (second substrate) and another substrate (first substrate) in an imaging device capable of shake correction by moving its solid-state imaging device. Among substrates that correspond to another substrate are a substrate having an image processing section adapted to process the imaging signal obtained by the solid-state imaging device mounted on the imaging substrate and a substrate having a control signal generating section adapted to generate signals that are used to control the solid-state imaging device mounted on the imaging substrate. Although a description will be given below assuming, for example, that the image processing section and control signal generating section are mounted on the same substrate (main substrate), this is not absolutely necessary.

The first communication device 100A has a semiconductor chip 103 that is capable of millimeter wave band transmission. The second communication device 200A has a semiconductor chip 203 that is also capable of millimeter wave band transmission.

In the first embodiment, only those signals that must be transmitted at high speed and in a large volume are transmitted in the millimeter wave band. Other signals that are acceptably transmitted at low speed and in a small volume and power that can be considered DC are not converted into a millimeter wave signal. These signals (including power) that are not converted into a millimeter wave signal are connected to the substrates by electrical wires. It should be noted that the original electrical signals to be transmitted before conversion into a millimeter wave signal are collectively referred to as baseband signals.

Among pieces of data, subject to conversion into a millimeter wave signal, that correspond to the data that must be transmitted at high speed and in a large volume, are an imaging signal obtained by the solid-state imaging device and a high-speed master clock signal supplied to the imaging substrate in the present embodiment which is an example of application to signal transmission between the imaging and main substrates in an imaging device. The high-speed master clock signal is an example of signals used to control the solid-state imaging device. A millimeter wave transmission system is built by converting the imaging and master clock signals into signals in the millimeter wave band from 30 to 300 GHz and transmitting the converted signals at high speeds.

### [First Communication Device]

The first communication device 100A has the semiconductor chip 103, capable of millimeter wave band transmission, and a transmission line coupling block 108 mounted on a substrate 102. The semiconductor chip 103 is a system LSI (Large Scale Integrated Circuit) that incorporates an LSI function block 104 and a signal generating block 107 (millimeter wave signal generating block) in a single chip. Although not illustrated, the LSI function block 104 and the signal generating block 107 may be provided separately from each other. If the two blocks are provided separately, the problems associated with the transmission of signals by electrical wires may arise. Therefore, it is preferred that the two blocks should be incorporated in a single chip. If the two sections are provided separately, the two chips (the LSI function block 104 and the signal generating block 107) should preferably be arranged close to each other to reduce possible adverse impact by keeping the wire bonding length to a minimum.

The signal generating block 107 and transmission line coupling block 108 are configured so that data is transmitted bidirectionally between the two blocks. Therefore, transmitting-side and receiving-side signal generation sections are provided in the signal generating block 107. As for the transmission line coupling block 108, two separate transmission line coupling sections may be provided, one for the transmitting side and another for the receiving side. Here, however, the transmission line coupling block 108 transmits and receives data.

It should be noted that “bidirectional communication” in the first embodiment is a single (single-core) bidirectional transmission with a single millimeter wave transmission channel, i.e., the millimeter wave signal transmission line 9. In order to accomplish this communication, time division duplex (TDD)-based half duplex, frequency division duplex (FDD: FIGS. 1B to 1E) or other schemes are used.

In the case of TDD, transmission and reception are separated in a time-divided manner. Therefore, “simultaneity of bidirectional communication (single-core bidirectional transmission)” is not achieved in which signal transmission from the first communication device 100A to the second communication device 200A and vice versa take place simultaneously. Instead, single-core bidirectional transmission is achieved by frequency division duplex. However, frequency division duplex uses different frequencies for transmission and reception, thus making it necessary to expand the transmission bandwidth of the millimeter wave signal transmission line 9.

Rather than mounting the semiconductor chip 103 directly on the substrate 102, the semiconductor chip 103 may be mounted on an interposer substrate first, after which the semiconductor package formed by molding the semiconductor chip 103, for example, with resin (e.g., epoxy resin) is mounted on the substrate 102. That is, the interposer substrate is used for chip mounting purposes. Therefore, the semiconductor chip 103 is mounted on the interposer substrate. A sheet member made of a combination of a thermally enhanced resin and copper foil need only be used as an interposer substrate. In this case, the thermally enhanced resin has a specific dielectric constant in a given range (about 2 to 10).

The semiconductor chip 103 is connected to the transmission line coupling block 108. An antenna structure having, for example, an antenna coupling section, antenna terminals, microstrip conductor and antenna, is used as the transmission line coupling block 108. It should be noted that the transmission line coupling block 108 can also be incorporated in the semiconductor chip 103 by using a technique adapted to form an antenna directly in the chip.

The LSI function block 104 takes charge of controlling major applications of the first communication device 100A. For example, therefore, the same block 104 includes circuits adapted to process a variety of signals to be transmitted to the other party (imaging substrate in the present example) and circuits adapted to process signals received from the other party. In the present embodiment which is an example of application to an imaging device, the same block 104 accommodates control, image processing and other circuits.

The signal generating block 107 (electric signal conversion section) converts the signal supplied from the LSI function block 104 into a millimeter wave signal and controls the signal transmission via the millimeter wave signal transmission line 9.

More specifically, the signal generating block 107 includes transmitting-side and receiving-side signal generating sections 110 and 120. The transmitting-side signal generating section 110 and transmission line coupling block 108 make up a transmission section, and the receiving-side signal generating section 120 and transmission line coupling block 108 a reception section.

The transmitting-side signal generating section 110 includes a multiplexing process section 113, parallel-to-serial conversion section 114, modulation section 115, frequency conversion section 116 and amplification section 117 to generate a millimeter wave signal by processing the input signal. It should be noted that the modulation section 115 and frequency conversion section 116 may be combined to provide a so-called direct conversion transmission section.

The receiving-side signal generating section 120 includes an amplification section 124, frequency conversion section 125, demodulation section 126, serial-to-parallel conversion section 127 and uniplexing process section 128 to generate an output signal by processing the millimeter wave electric signal received by the transmission line coupling block 108. The frequency conversion section 125 and demodulation section 126 may be combined to provide a so-called direct conversion reception section.

The parallel-to-serial conversion section 114 and serial-to-parallel conversion section 127 are provided for a parallel interface using a plurality of parallel transmission signals if the present embodiment is not applied. The same sections 114 and 127 are not required for a serial interface.

In the presence of a plurality of types of signals to be transmitted in the millimeter wave band (N1 types) of all the signals supplied from the LSI function block 104, the multiplexing process section 113 combines the plurality of types of signals into a single signal through multiplexing including time division multiplexing, frequency division multiplexing and code division multiplexing. In the first embodiment, the same section 113 combines the plurality of types of signals that must be transmitted at high speed and in a large volume into a single signal for millimeter wave signal transmission.

It should be noted that, in the case of time or code division multiplexing, the multiplexing process section 113 need only be provided at the previous stage of the parallel-to-serial conversion section 114 so that the same section 113 combines the plurality of types of signals into a single signal and supplies the signal to the parallel-to-serial conversion section 114. In the case of time division multiplexing, a selector switch need only be provided to divide the available time into time slots among the plurality of types of signals _@ (where @ is any one of 1 to N1). A uniplexing process section 228 is provided in the second communication device 200A in association with the multiplexing process section 113 to divide the single combined signal back into the N1 signals.

In the case of frequency division multiplexing, on the other hand, it is necessary to generate millimeter wave signals by converting the signals into frequencies, each in one of frequency bands F_@ that are different from each other, as illustrated in FIG. 1C. Therefore, it is only necessary to provide the parallel-to-serial conversion section 114, modulation section 115, frequency conversion section 116 and amplification section 117 for each of the plurality of types of signals _@ and additionally provide an addition section at the subsequent stage of the amplification sections 117 to serve as the multiplexing process section 113. Then, it is only necessary to supply the frequency-division-multiplexed millimeter wave electric signal containing the frequency bands F_1 to F_N1 to the transmission line coupling block 108.

As is clear from FIG. 1C, the transmission bandwidth must be wide in frequency division multiplexing which combines the plurality of signals into a single signal. If different frequencies are used for transmission (from the transmitting-side signal generating section 110 to a receiving-side signal generating section 220) and reception (from a transmitting-side signal generating section 210 to the receiving-side signal generating section 120), the transmission bandwidth must be increased further as illustrated in FIGS. 1D and 1E.

The parallel-to-serial conversion section 114 converts parallel signals into a serial data signal and supplies the signal to the modulation section 115. The modulation section 115 modulates the signal to be transmitted and supplies the resultant signal to the frequency conversion section 116. The modulation section 115 need only modulate one of the amplitude, frequency and phase of the signal to be transmitted. Further, an arbitrary combination of these options may be used. For example, the analog modulation schemes include amplitude modulation (AM) and vector modulation. Among vector modulation schemes are frequency modulation (FM) and phase modulation (PM). On the other hand, the available digital modulation schemes includes amplitude shift keying (ASK), frequency shift keying (FSK), phase shift keying (PSK) and amplitude phase shift keying (APSK). Amplitude phase shift keying modulates both the amplitude and phase. As for amplitude phase shift keying, quadrature amplitude modulation (QAM) is a typical example.

The frequency conversion section 116 frequency-converts the signal to be transmitted that has been modulated by the modulation section 115 to generate a millimeter wave electric signal and supplies the signal to the amplification section 117. The term “millimeter wave electric signal” refers to an electric signal at a frequency falling generally within the range from 30 to 300 GHz. The term “generally” was added based on the fact that the millimeter wave electric signal need only be at a frequency that provides the effect of the millimeter wave signal transmission of the first embodiment and that the lower and upper limits of this frequency are not limited to 30 and 300 GHz, respectively.

The frequency conversion section 116 can be configured in a variety of ways. However, the same section 116 need only include a mixer circuit and local oscillator. The local oscillator generates a carrier (carrier signal or reference carrier) for use in modulation. The mixer circuit generates a modulated signal by modulating the carrier in the millimeter wave band generated by the local oscillator with the signal supplied from the parallel-to-serial conversion section 114, supplying the modulated signal to the amplification section 117.

The amplification section 117 amplifies the millimeter wave electric signal obtained from the frequency conversion and supplies the amplified signal to the transmission line coupling block 108. The amplification section 117 is connected to the bidirectional transmission line coupling block 108 via an unshown antenna terminal.

The transmission line coupling block 108 transmits the millimeter wave signal, generated by the transmitting-side signal generating section 110, to the millimeter wave signal transmission line 9. The same block 108 also receives a millimeter wave signal from the millimeter wave signal transmission line 9 and outputs the signal to the receiving-side signal generating section 120.

The transmission line coupling block 108 includes an antenna coupling section. The antenna coupling section is an example of or makes up part of the transmission line coupling block 108. The term “antenna coupling section” refers, in a narrow sense, to a section adapted to couple electronic circuitry in a semiconductor chip and the antenna provided inside or outside the chip together, and, in a broad sense, to a section adapted to achieve signal coupling between a semiconductor chip and millimeter wave signal transmission line.

For example, the antenna coupling section includes at least an antenna structure. Further, when transmission and reception is conducted through time division multiplexing, an antenna selector section (antenna duplexer) is provided in the transmission line coupling block 108.

The term “antenna structure” refers to the structure of the coupling section adapted to achieve coupling with the millimeter wave signal transmission line 9. This structure need only be able to couple the electric signal in the millimeter wave band to the millimeter wave signal transmission line 9. Therefore, the term “antenna structure” does not refer to antenna itself. For example, the antenna structure includes an antenna terminal, microstrip conductor and antenna. If the antenna selector section is formed in the same chip, the antenna terminal and microstrip conductor make up the transmission line coupling block 108.

The antenna is made of an antenna material having a length based on a wavelength λ of the millimeter wave signal (e.g., about 600 μl) and coupled to the millimeter wave signal transmission line 9. A patch antenna, probe antenna (e.g., dipole probe antenna), loop antenna, small-size aperture coupling element (e.g., slot antenna) or other antenna is used as the antenna.

When the antennas of the first and second communication devices 100A and 200A are arranged to be opposed to each other, the antennas need only be nondirectional. If the antennas are arranged out of alignment with each other in plan view, they should be directional. Alternatively, the direction of travel should be changed from the direction of thickness of the substrate to the direction of plane thereof by using a reflecting member. Still alternatively, a dielectric transmission line, for example, should be provided to permit travel in the direction of plane.

The transmitting-side antenna radiates an electromagnetic wave based on a millimeter wave signal to the millimeter wave signal transmission line 9. On the other hand, the receiving-side antenna receives an electromagnetic wave based on a millimeter wave signal from the millimeter wave signal transmission line 9. The microstrip conductor connects the antenna terminal and antenna, transmitting the transmitting-side millimeter wave signal from the antenna terminal to the antenna and the receiving-side millimeter wave signal from the antenna to the antenna terminal.

The antenna selector section is used when the antenna is used for both transmission and reception. For example, when a millimeter wave signal is transmitted to the second communication device 200A, i.e., the other party, the antenna selector section connects the antenna to the transmitting-side signal generating section 110. On the other hand, when a millimeter wave signal is received from the second communication device 200A, i.e., the other party, the antenna selector section connects the antenna to the receiving-side signal generating section 120. Although provided on the substrate 102 separately from the semiconductor chip 103, the antenna selector section may be provided in the semiconductor chip 103. The antenna selector section can be eliminated if two separate antennas are provided, one for transmission and another for reception.

The millimeter wave signal transmission line 9, i.e., a millimeter wave propagation path, may be a free space transmission line. However, the same line 9 should preferably include a waveguide structure such as waveguide, transmission path, dielectric waveguide or dielectric-coated transmission line to transmit electromagnetic wave in the millimeter wave band with high efficiency. For example, the same line 9 should be a dielectric transmission line that includes a dielectric material having a specific dielectric constant in a given range and a dielectric tangent in a given range.

The “given range” need only be a range within which the specific dielectric constant or dielectric tangent of the dielectric material should fall to provide the effect of the present embodiment. This range need only be determined in advance for this purpose. That is, the dielectric material need only have a property that permits transmission of a millimeter wave in such a manner as to provide the effect of the present embodiment. This range cannot be determined based only on the dielectric material itself. Instead, the range is also related to the transmission line length and millimeter wave frequency, as well. Therefore, this range cannot be determined in a clear-cut manner. As a result, the following is given as an example.

That is, in order for a millimeter wave to be transmitted at high speed in a dielectric transmission line, the specific dielectric constant of the dielectric material should be about 2 to 10 (preferably 3 to 6) and the dielectric tangent thereof 0.00001 to 0.01 (preferably 0.00001 to 0.001). Among dielectric materials that meet these requirements are acrylic resin-based, urethane-based, epoxy resin-based, silicone-based, polyimide-based and cyanoacrylate resin-based materials. These ranges of specific dielectric constant and dielectric tangent of dielectric materials also apply to other embodiments of the present invention unless otherwise specified. It should be noted that the millimeter wave signal transmission line 9 structured to trap a millimeter wave signal therein may be not only a dielectric transmission line but also a hollow waveguide in which the transmission line is surrounded by a hollow shielding material. When made of an electrical conductor such as metal member, the shielding material ensures more positive shielding than when it is not.

The receiving-side signal generating section 120 is connected to the transmission line coupling block 108. The amplification section 124 of the receiving-side signal generating section 120 is connected to the transmission line coupling block 108, amplifies the millimeter wave signal received by the antenna and supplies the amplified signal to the frequency conversion section 125. The same section 125 frequency-converts the amplified millimeter wave electric signal and supplies the frequency-converted signal to the demodulation section 126. The same section 126 demodulates the frequency-converted signal and supplies the demodulated signal to the serial-to-parallel conversion section 127.

The serial-to-parallel conversion section 127 converts the serial received data into parallel output data and supplies the data to the uniplexing process section 128.

The uniplexing process section 128 is associated with a multiplexing process section 213 of the transmitting-side signal generating section 210. For example, in the presence of a plurality of types of signals to be transmitted in the millimeter wave band (N2 types; whether N2 is the same as or different from N1 is ignored) of all the signals supplied from an LSI function block 204, the multiplexing process section 213 combines the plurality of types of signals into a single signal through multiplexing including time division multiplexing, frequency division multiplexing and code division multiplexing, as does the multiplexing process section 113. Upon receipt of such a signal from the second communication device 200, the uniplexing process section 128 separates the single combined signal into a plurality of signals _@ (where @ is any one of 1 to N2) as does the uniplexing process section 228 associated with the multiplexing process section 113. In the first embodiment, for example, the uniplexing process section 128 separates the single combined signal into N2 data signals and supplies these signals to the LSI function block 104.

It should be noted that, in the presence of a plurality of (N2) types of signals to be transmitted in the millimeter wave band of all the signals supplied from the LSI function block 204, these signals may be combined into a single signal through frequency division multiplexing by the transmitting-side signal generating section 210 in the second communication device 200A. In this case, it is necessary to receive the frequency-division-multiplexed millimeter wave electric signal containing the frequency bands F_1 to F_N2 and process the signal for each frequency band F_@. Therefore, a set of the amplification section 124, frequency conversion section 125, demodulation section 126 and serial-to-parallel conversion section 127 should be provided for each of the plurality of types of signals _@. A frequency separation section is provided as the uniplexing process section 128 at the previous stage of each of the amplification sections 124 (see FIG. 1C). Then, it is only necessary to supply the separated millimeter wave electric signals in the respective frequency bands F_@ to the blocks of the associated frequency bands F_@.

When the semiconductor chip 103 is configured as described above, the input signal is converted from parallel to serial data which is then transmitted to the semiconductor chip 203. On the other hand, the signal received from the semiconductor chip 203 is converted from serial to parallel data, thus providing a reduced number of signals to be changed into millimeter wave signals.

It should be noted that if serial data transmission is originally used between the first and second communication devices 100A and 200A, there is no need to provide the parallel-to-serial conversion section 114 and serial-to-parallel conversion section 127.

### [Second Communication Device]

As already described about the uniplexing process section 228 in relation to the multiplexing process section 113, and also as already described regarding the multiplexing process section 213 in relation to the uniplexing process section 128, the second communication device 200A has roughly the same functional configuration as the first communication device 100A in other respects. Each function section is denoted by a 200 series number as a reference numeral. The same or similar function sections as those of the first communication device 100A are denoted by the same 10- and 1-series numbers as reference numerals, as is done with the first communication device 100A. The transmission section includes the transmitting-side signal generating section 210 and a transmission line coupling block 208, and the reception section the receiving-side signal generating section 220 and transmission line coupling block 208.

The LSI function block 204 takes charge of controlling major applications of the second communication device 200A. For example, therefore, the same block 204 includes circuits adapted to process a variety of signals to be transmitted to the other party (main substrate in the present example) and circuits adapted to process signals received from the other party. In the present embodiment which is an example of application to an imaging device, the same block 204 accommodates, for example, a solid-state imaging device and imaging drive section.

Here, the technique of frequency-converting an input signal for transmission is common in broadcasting and wireless communication. In these applications, relatively complex transmitters and receivers are used to address the problems including α) over how much distance communication is possible (S/N ratio problem in relation to thermal noise), β) how to address the reflection and multipath problems, and γ) how to suppress jamming and interference. In contrast, the signal generating blocks 107 and 207 used in the present embodiment employ the millimeter wave band that is higher than the frequencies used by the complex transmitters and receivers that are common in broadcasting and wireless communication. The short wavelength λ allows for easy frequency reuse, making the signal generating blocks 107 and 207 fit for communication between a number of nearby devices.

### [Connection and Operation: First Embodiment]

Unlike existing electrical wired signal interface, the first embodiment performs signal transmission in the millimeter wave band as described earlier, flexibly handling high-speed and large-volume signal transmission. In the first embodiment, for example, only those signals that must be transmitted at high speed and in a large volume are transmitted in the millimeter wave band. The communication devices 100 and 200 each include an existing electrical wired signal interface (connections using terminals and connectors) for low-speed and small-volume signals and power.

The signal generating block 107 generates a millimeter wave signal by processing the input signal fed from the LSI function block 104. The same block 107 is connected to the transmission line coupling block 108, for example, by a transmission path such as microstrip line, strip line, coplanar line or slot line. The generated millimeter wave signal is supplied to the millimeter wave signal transmission line 9 via the transmission line coupling block 108.

Having an antenna structure, the transmission line coupling block 108 converts the transmitted millimeter wave signal into electromagnetic wave and outputs the converted electromagnetic wave. The same block 108 is coupled to the millimeter wave signal transmission line 9. The electromagnetic wave converted by the transmission line coupling block 108 is supplied to one end of the millimeter wave signal transmission line 9. The transmission line coupling block 208 of the second communication device 200A is connected to the other end of the millimeter wave signal transmission line 9. Providing the millimeter wave signal transmission line 9 between the transmission line coupling block 108 of the first communication device 100A and the transmission line coupling block 208 of the second communication device 200A permits propagation of the electromagnetic wave in the millimeter wave band through the same line 9.

The transmission line coupling block 208 of the second communication device 200A is coupled to the millimeter wave signal transmission line 9. The same block 208 receives the electromagnetic wave transmitted to the other end of the millimeter wave signal transmission line 9, converts it into a millimeter wave signal and supplies the signal to the signal generating block 207 (baseband signal generating block). The same block 207 processes the converted millimeter wave signal to generate an output signal (baseband signal) and supplies the signal to the LSI function block 204.

For example, a high-frequency master clock signal, generated by the control circuit on the main substrate equipped with the first communication device 100A, is converted into a millimeter wave signal. The millimeter wave signal is then transmitted via the millimeter wave signal transmission line 9 to the imaging substrate equipped with the second communication device 200A. The same device 200A converts the millimeter wave signal back into the original master clock signal and generates a signal adapted to drive the solid-state imaging device based on the master clock signal.

Here, although a description was given taking, as an example, signal transmission from the first communication device 100A to the second communication device 200A, the same is true when a signal is transmitted from the LSI function block 204 of the second communication device 200A to the first communication device 100A. A millimeter wave signal can be transmitted in both directions. For example, an imaging signal obtained by the solid-state imaging device on the imaging substrate equipped with the second communication device 200A is converted into a millimeter wave signal and transmitted via the millimeter wave signal transmission line 9 to the main substrate equipped with the first communication device 100A. The first communication device 100A converts the millimeter wave signal back into the original imaging signal to obtain the image signal for recording or display purposes.

### [Functional Configuration: Comparative Example]

As illustrated in FIG. 2, a signal transmission system 1Z of a comparative example includes first and second devices 100Z and 200Z. The same devices 100Z and 200Z are coupled together via an electrical interface 9Z for signal transmission. A semiconductor chip 103Z is provided in the first device 100Z. The same chip 103Z is capable of signal transmission via electrical wires. Similarly, a semiconductor chip 203Z is provided in the second device 200Z. The same chip 203Z is also capable of signal transmission via electrical wires. In this configuration, the millimeter wave signal transmission line 9 of the first embodiment is replaced by the electrical interface 9Z.

In order to achieve signal transmission via electrical wires, the first device 100Z has an electric signal conversion block 107Z in place of the signal generating block 107 and transmission line coupling block 108. The second device 200Z has an electric signal conversion block 207Z in place of the signal generating block 207 and transmission line coupling block 208.

In the first device 100Z, the electric signal conversion block 107Z controls the electric signal transmission via the electrical interface 9Z for the LSI function block 104. In the second device 200Z, on the other hand, the electric signal conversion block 207Z is accessed via the electrical interface 9Z and receives the data from the LSI function block 104.

Here, the signal transmission system 1Z of the comparative example using the electrical interface 9Z has the following problems.

i) In spite of need for data transmission in a larger volume and at a higher speed, electrical wires have their limitations in transmission speed and volume.

ii) A possible approach to increasing the data transmission speed would be to provide parallel signals by increasing the number of wires and reduce the transmission speed of each signal line. However, this remedy leads to an increased number of input and output terminals. Consequently, more complicated printed circuit boards and cabling are required. Also, the physical sizes of the connectors and electrical interface 9Z must be increased. This leads to more complicated geometries of the connectors and electrical interface, resulting in degraded reliability and increased cost.

iii) As a result of enormous expansion in the amount of information including movie pictures and computer graphics, the baseband signal bandwidth expands, causing the EMC (electromagnetic compatibility) problem to manifest itself. For example, an electrical wire, if used, acts as an antenna, interfering with the signals at a frequency matching the tuning frequency of the antenna. Moreover, reflection and resonance resulting from unmatched wire impedance may give rise to unwanted radiation. Resonance or reflection, if present, is likely to be accompanied by emission, making the EMC (electromagnetic interference) problem more serious. In order to address these problems, the imaging device becomes more complex in configuration.

iv) In addition to EMC and EMI, reflection may cause transmission errors due to interference between symbols at the receiving side and intrusion of jamming wave.

In contrast, the electric signal conversion blocks 107Z and 207Z of the comparative example are replaced by the signal generating blocks 107 and 207 and transmission line coupling blocks 108 and 208 in the wireless transmission system 1A of the first embodiment, thus achieving signal transmission by using a millimeter wave signal rather than electrical wires. A signal to be transmitted from the LSI function block 104 to the LSI function block 204 is converted into a millimeter wave signal which is then transmitted from the transmission line coupling block 108 to the transmission line coupling block 208 via the millimeter wave signal transmission line 9.

Thanks to wireless transmission, there is no need to be concerned about wire geometries or connector positions. As a result, there are not many restrictions in layout. The wires and terminals can be omitted for those signals that are transmitted with a millimeter wave signal, thus resolving the EMC and EMI problems. There are in general no other function sections using frequencies in the millimeter wave band in the communication devices 100 and 200, readily providing countermeasures against the EMC and EMI problems.

Further, this wireless transmission takes place between the first and second communication devices 100 and 200 in proximity to each other, with signals transmitted between fixed positions or in a known positional relationship. As a result, this wireless transmission provides the advantages listed below.

1) Easy to properly design the propagation channel (waveguide structure) between the transmitting and receiving sides.
2) Designing the dielectric structure of the transmission line coupling section adapted to seal the transmitting and receiving sides and the propagation channel (waveguide structure of the millimeter wave signal transmission line 9) together permits excellent transmission with higher reliability than in free space transmission.
3) The controller adapted to control the wireless transmission (the LSI function block 104 in the present example) need not do so in a dynamic, adaptive and frequent manner as is required in common wireless transmission, thus making it possible to reduce the control overhead to a level smaller than that of common wireless transmission. This permits downsizing, reduction in power consumption and faster transmission.
4) Understanding individual variation, for example, by calibrating the wireless transmission environment during manufacture or design ensures higher quality in communication by referencing the individual variation data.
5) Even in the presence of reflection, this is fixed reflection. Therefore, the impact thereof can be readily removed with a small equalizer. The equalizer can be readily set up with presets or through static control.

Further, millimeter wave transmission provides the advantages listed below.

a) A wide communication band can be secured in millimeter wave transmission, making it easy to deliver a high data rate.

b) The transmission frequency can be separated from the frequencies used for processing other baseband signals, making it unlikely for interference between the millimeter wave and baseband signals to take place and making it easy to achieve space division multiplexing which will be described later.

c) A short wavelength of the millimeter wave band allows for downsizing of the antenna and waveguide structure whose lengths are determined according to the wavelength. In addition, electromagnetic shielding is easy to achieve thanks to large distance attenuation and small diffraction.

d) The carrier stability is rigorously regulated to prevent interference in the ordinary wireless communication. In order to achieve such a highly stable carrier, highly stable external frequency reference components, frequency multiplier and PLL (phase locked loop circuit) are, for example, used, thus resulting in increased circuit scale. However, millimeter wave can be readily shielded to prevent external leaks (particularly when used in combination with signal transmission between fixed positions or in a known positional relationship), making it possible to use a carrier that is low in stability for transmission and preventing the increase in circuit scale. Injection locking (described in detail later) is preferred to demodulate a signal transmitted on a less stable carrier with a small circuit at the receiving side.

### <Wireless Transmission System: Second Embodiment>

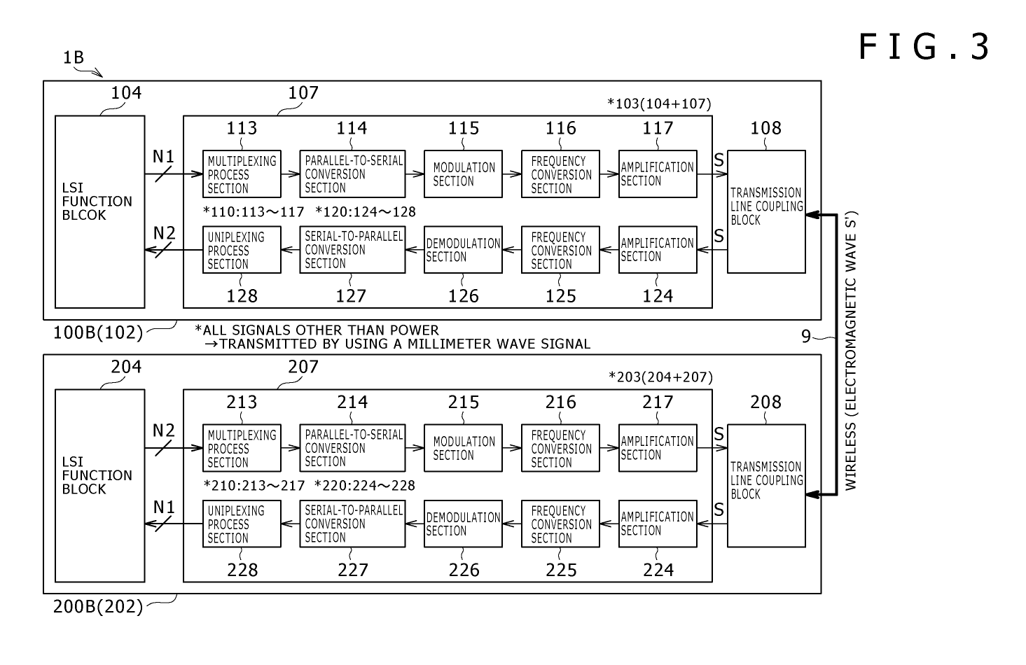

FIG. 3 is a diagram describing a signal interface of a wireless transmission system according to a second embodiment. Here, FIG. 3 is a diagram describing the signal interface of a wireless transmission system 1B according to the second embodiment in terms of functional configuration.

In the second embodiment, not only those signals that must be transmitted at high speed and in a large volume but also other signals that are acceptably transmitted at low speed and in a small volume are transmitted in the millimeter wave band. Only power is not converted into a millimeter wave signal. Among other signals that are acceptably transmitted at low speed and in a small volume are control signals transmitted to the imaging substrate and horizontal and vertical synchronizing signals in the present embodiment which is an example of application to an imaging device. Control signals transmitted to the imaging substrate and horizontal and vertical synchronizing signals are examples of signals used to control the solid-state imaging device.

In the arrangement according to the second embodiment, all signals other than power are transmitted by using a millimeter wave signal. As for power that is not converted into a millimeter wave signal, connection is made between the LSI function blocks 104 and 204 (substrates) by electrical wires as is done in the comparative example described earlier.

The second embodiment differs in terms of functional configuration from the first embodiment merely in the signals to be converted into a millimeter wave signal. Therefore, the description of other points of the second embodiment is omitted.

### <Wireless Transmission System: Third Embodiment>

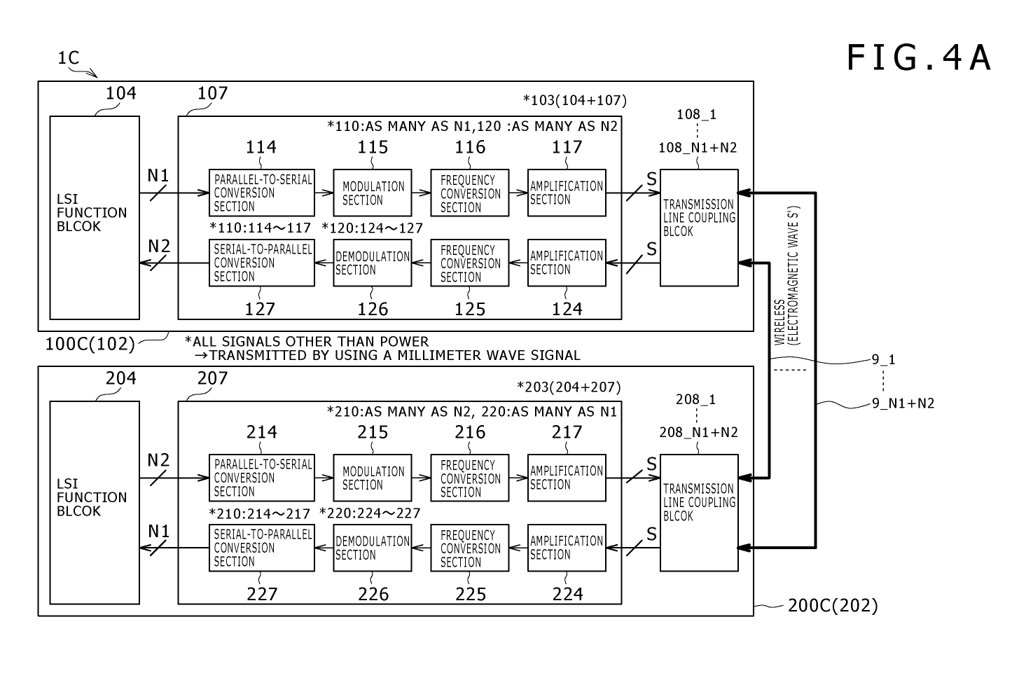

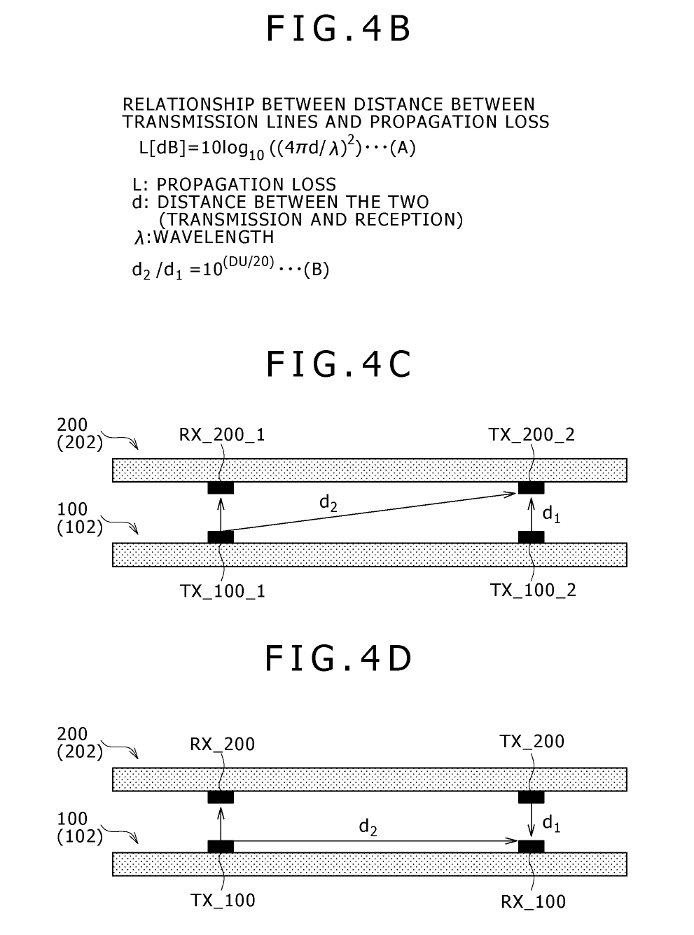

FIGS. 4A to 4D are diagrams describing a signal interface of a wireless transmission system according to a third embodiment. Here, FIG. 4A is a diagram describing the signal interface of a wireless transmission system 1C according to the third embodiment in terms of functional configuration, and FIGS. 4B to 4D are diagrams describing proper conditions for space division multiplexing.

The wireless transmission system 1C according to the third embodiment includes the millimeter wave signal transmission line 9 by using a plurality of pairs of the transmission line coupling blocks 108 and 208. We assume that the plurality of millimeter wave signal transmission lines 9 are arranged so as not to interfere with each other and so as to be able to communicate concurrently at the same frequency. In the present embodiment, such an arrangement is referred to as space division multiplexing. If space division multiplexing is not used to provide multiple channels, frequency division multiplexing must be used, with different carrier frequencies used for the different channels. However, space division multiplexing permits signal transmission at the same frequency while remaining immune to interference.

The “space division multiplexing” need only form the plurality of millimeter wave signal transmission lines 9 in a three-dimensional space which permits transmission of a millimeter wave signal (electromagnetic wave), and is not limited to forming the plurality of millimeter wave signal transmission lines 9 in a free space. For example, when a three-dimensional space which permits transmission of a millimeter wave signal (electromagnetic wave) includes a dielectric material (tangible object), space division multiplexing may form the plurality of millimeter wave signal transmission lines 9 in the dielectric material. Further, each of the plurality of millimeter wave signal transmission lines 9 is not limited to being a free space, but may take on the form of a dielectric transmission line or hollow waveguide.

Space division multiplexing allows for concurrent use of the same frequency band, thus providing higher transmission speed. Moreover, the simultaneity of bidirectional communication can be guaranteed in which the signal transmission from a first communication device 100C to a second communication device 200C over N1 channels and that from the second communication device 200C to the first communication device 100C over N2 channels takes place concurrently. In particular, the millimeter wave is expected to attenuate thanks to its short wavelength, making interference unlikely even with a small offset (small spatial distance between transmission channels). As a result, it is easy to achieve a different propagation channel depending on the location.

As illustrated in FIG. 4A, the wireless transmission system 1C according to the third embodiment includes the N1+N2 transmission line coupling blocks 108 and 208, each having a millimeter wave transmission terminal, millimeter wave signal transmission line, antenna and other components. The same system 1C also includes the N1+N2 millimeter wave signal transmission lines 9. Each of the transmission line coupling blocks 108 and 208 and millimeter wave signal transmission lines 9 is assigned reference numeral _@ (where @ is any one of 1 to N1+N2). This provides a full duplex transmission system in which millimeter wave transmission and reception are carried out independently of each other.

The first communication device 100C is devoid of the multiplexing process section 113 and uniplexing process section 128. The second communication device 200C is devoid of the multiplexing process section 213 and uniplexing process section 228. In this example, all signals other than power are transmitted by using a millimeter wave signal. It should be noted that this example is similar to the example of frequency division multiplexing shown in FIG. 1C. In the present embodiment, however, the N1 transmitting-side signal generating sections 110 and N1 receiving-side signal generating sections 220 are provided. Also, the N2 transmitting-side signal generating sections 210 and N2 receiving-side signal generating sections 120 are provided.

The carrier frequencies may be the same as or different from each other. In the case of dielectric transmission lines or hollow waveguides, for example, millimeter wave signals are trapped therein. This prevents interference therebetween, thus causing no problem even if the same carrier frequency is used. In the case of free space transmission lines, on the other hand, there is no problem so long as the transmission lines are spaced at some distance from each other. However, if they are at a close distance from each other, the carrier frequencies should be different.

For example, propagation loss L in free space can be expressed by equation L[dB]=10 log₁₀((4πd/λ)²) . . . (A) where d is the distance and λ the wavelength, as illustrated in FIG. 4B.

We consider two types of space division multiplexed transmission as illustrated in FIGS. 4B to 4D. In these figures, the transmitter is denoted by TX, and the receiver by RX. Reference numerals _100 represent the side of the first communication device 100, and reference numerals _200 the side of the second communication device 200. In FIG. 4C, the first communication device 100 includes two transmitters or transmitters TX_100_1 and TX_100_2. On the other hand, the second communication device 200 includes two receivers or receivers RX_200_1 and RX_200_2. That is, the signal transmission from the first communication device 100 to the second communication device 200 takes place between the transmitter TX_100_1 and the receiver RX_200_1 and also between the transmitter TX_100_2 and the receiver RX_200_2. That is, the signal transmission from the first communication device 100 to the second communication device 200 is conducted via two routes.

In FIG. 4D, on the other hand, the first communication device 100 includes a transmitter TX_100 and receiver RX_100, and the second communication device 200 includes a transmitter TX_200 and receiver RX_200. That is, the signal transmission from the first communication device 100 to the second communication device 200 takes place between the transmitter TX_100 and the receiver RX_200, whereas the signal transmission from the second communication device 200 to the first communication device 100 takes place between the transmitter TX_200 and the receiver RX_100. Two communication channels are used, one for transmission and another for reception, to implement a full duplex scheme which permits simultaneous data transmission (TX) and reception (RX) from both sides.

Here, the relationship between an antenna-to-antenna distance d₁ required to provide necessary DU [dB] (ratio between wanted and unwanted waves) and a spatial spacing d₂ between channels (more specifically, separation distance between free space transmission lines 9B) when a nondirectional antenna is used is given by equation d₂/d₁=10^{(DU/20)} . . . (B) from equation (A).

For example, when DU is 20 dB, d₂/d₁ is 10. As a result, d₂ must be 10 times larger than d₁. Normally, antennas are directional to a certain extent. Therefore, even if free space transmission lines 9B are used, d₂ can be set shorter than the above.

For example, when the distance to the antenna of the other party is shorter, the transmission power of each antenna can be kept low. If the transmission power is sufficiently low, with the pair of antennas arranged sufficiently away from each other, it is possible to suppress interference between the antennas to a sufficiently low level. In millimeter wave transmission in particular, the signal attenuates significantly with distance with a small diffraction thanks to its short wavelength, making it easy to achieve space division multiplexing. For example, even if the free space transmission lines 9B are used, the spatial spacing d₂ between channels (separation distance between free space transmission lines 9B) can be set shorter than 10 times the antenna-to-antenna distance d₁.

Dielectric transmission lines or hollow waveguides can trap the millimeter waves therein during transmission. Therefore, the spatial spacing d₂ between channels (separation distance between free space transmission lines 9B) can be reduced to less than 10 times the antenna-to-antenna distance d₁. In particular, the spacing between channels can be reduced more than when the free space transmission lines 9B are used.

For example, among possible schemes for achieving bidirectional transmission are time division multiplexing and frequency division multiplexing described in the first embodiment in addition to space division multiplexing.

In the first embodiment, either a half duplex or full duplex scheme is used to provide data transmission and reception with the single millimeter wave signal transmission line 9. The half duplex scheme switches between transmission and reception through time division multiplexing. The full duplex scheme performs transmission and reception concurrently through frequency division multiplexing.

It should be noted, however, that time division multiplexing has a drawback in that transmission and reception cannot be conducted concurrently. As for frequency division multiplexing, on the other hand, it necessary to expand the bandwidth of the millimeter wave signal transmission line 9 as illustrated in FIGS. 1B to 1E.

In contrast, the wireless transmission system 1C according to the third embodiment permits the same carrier frequency to be set for a plurality of signal transmission routes (plurality of channels), thus making it easy to reuse the carrier frequencies. Transmission and reception can be conducted concurrently without expanding the bandwidth of the millimeter wave signal transmission line 9. The transmission speed can be increased by using the same frequency band at the same time for a plurality of transmission channels in the same direction.

When the N millimeter wave signal transmission lines 9 are available for N (N=N1=N2) baseband signals, it is only necessary to use time or frequency division multiplexing to achieve bidirectional transmission and reception. On the other hand, if the 2N millimeter wave signal transmission lines 9 are used, it is possible to achieve bidirectional transmission and reception using the different millimeter wave signal transmission lines 9 (transmission lines that are all independent of each other). That is, when N types of signals are transmitted in the millimeter wave band, these signals can be transmitted over the 2N different millimeter wave signal transmission lines 9 without resorting to multiplexing such as time, frequency or code division multiplexing.

### <Wireless Transmission System: Fourth Embodiment>

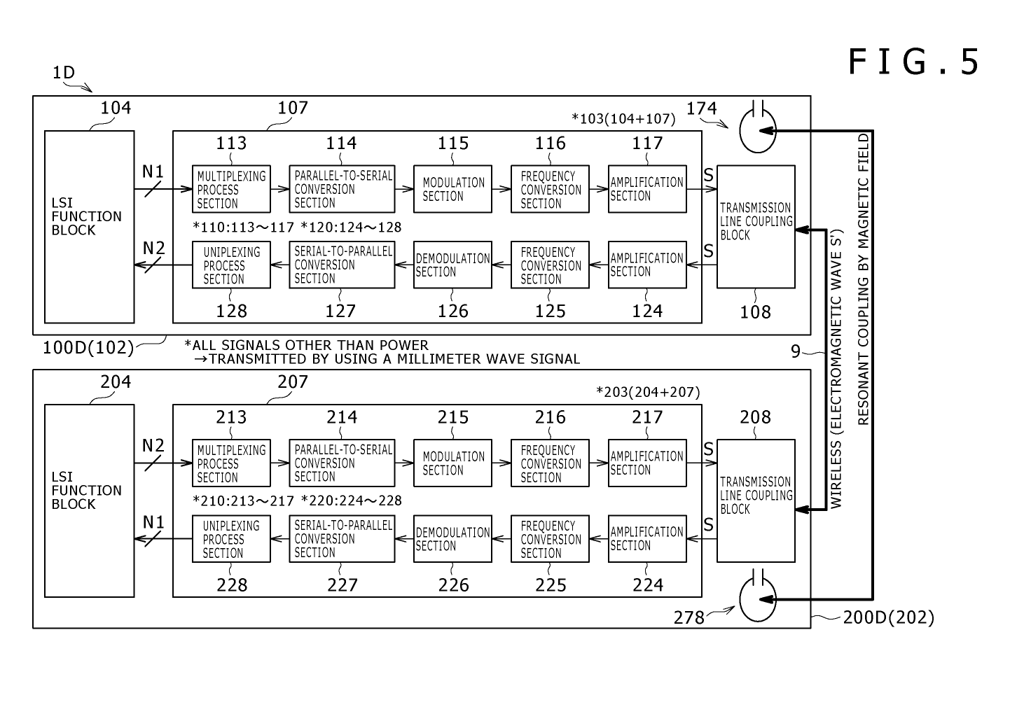

FIG. 5 is a diagram describing a signal interface of a wireless transmission system according to a fourth embodiment. Here, FIG. 5 is a diagram describing the signal interface of a wireless transmission system 1D according to the fourth embodiment in terms of functional configuration. The fourth embodiment is a modification example of the second embodiment.

The wireless transmission system 1D according to the fourth embodiment is based on the system according to the second embodiment that transmits those signals that must be transmitted at high speed and in a large volume and other signals that are acceptably transmitted at low speed and in a small volume in the millimeter wave band. In addition, the system 1D according to the fourth embodiment also wirelessly transmits power. That is, a new arrangement is added that is designed to wirelessly supply power to be consumed by the imaging substrate equipped with a second communication device 200D from a first communication device 100D.

The first communication device 100D includes a power supply section 174 adapted to wirelessly supply power to be consumed by the second communication device 200D. The arrangement of the power supply section 174 will be described later.

The second communication device 200D includes a power reception section 278 adapted to receive power transmitted wirelessly from the first communication device 100D. Although the arrangement of the power reception section 278 will be described later, the same section 278 generates source voltages for use in the second communication device 200D and supplies these voltages, for example, to the semiconductor chip 203, irrespective of the method used.

In terms of functional configuration, the fourth embodiment differs from the second embodiment merely in that it transmits power wirelessly. Therefore, the description of other points of the fourth embodiment is omitted. One of the electromagnetic induction, radio wave reception and resonance methods is used for wireless power transmission. Any of these methods completely eliminates the need for any interface using electrical wires or terminals, thus providing a system without using any cables. All signals including power can be transmitted wirelessly from the first communication device 100D to the second communication device 200D. FIG. 5 shows a configuration based on the magnetic field resonance method.

For example, the electromagnetic induction method relies on the electromagnetic coupling and electromotive force induced in coils. Although not illustrated, the power supply section (transmitting side or primary side) adapted to supply power wirelessly includes a primary coil and drives the primary coil at a relatively high frequency. The power reception section (receiving side or secondary side) adapted to receive power wirelessly from the power supply section includes a secondary coil, rectifying diode, resonance and smoothing capacitors and so on. The secondary coil is provided to be opposed to the primary coil. For example, the rectifying diode and smoothing capacitor make up a rectifying circuit.

When the primary coil is driven at a high frequency, an induced electromotive force is generated in the secondary coil that is electromagnetically coupled to the primary coil. A DC voltage is generated by the rectifying circuit based on this induced electromotive force. At this time, the power reception efficiency is enhanced by taking advantage of the resonance effect.

When the electromagnetic induction method is used, the power supply section and power reception section are arranged close to each other, with no other members (no metallic members in particular) provided therebetween (more specifically, between the primary and secondary coils). At the same time, the coils are electromagnetically shielded. The former is intended to prevent heating of the metallic members (based on the principle of electromagnetic induction heating). The latter is designed to protect other electronic circuitry from electromagnetic interference. Although capable of transmitting large power, the electromagnetic induction method requires the transmitting and receiving sides to be arranged close to each other (e.g., 1 cm or less) as described earlier.

The radio wave reception relies on radio wave energy and is designed to convert an AC waveform, obtained by the reception of radio wave, into a DC voltage using a rectifying circuit. This method is advantageous in that power can be transmitted irrespective of the frequency (e.g., millimeter wave allowed). Although not illustrated, the power supply section (transmitting side) adapted to supply power wirelessly includes a transmission circuit adapted to transmit radio wave in a given frequency band. The power reception section (receiving side) adapted to receive power wirelessly from the power supply section includes a rectifying circuit adapted to rectify the received radio wave. Although varying depending on the power to be transmitted, the received voltage should preferably be small, and a diode (e.g., Schottky diode) having as small a forward voltage as possible should preferably be used in the rectifying circuit. It should be noted that a resonance circuit may be provided at the previous stage of the rectifying circuit to increase the voltage for rectification. The radio wave reception method for common outdoor use has low power transmission efficiency due to dispersion of the majority of transmitted power. However, when used in combination with the configuration adapted to limit the transmission area (millimeter wave signal transmission line structured to trap the signal therein), the radio wave reception method is likely to resolve the above problem.

The resonance method relies on the same principle as that in which two oscillators (pendulums or tuning forks) resonate and takes advantage of resonance in a near electric or magnetic field rather than electromagnetic wave. The resonance method uses the fact that when one of the two oscillators (equivalent to the power supply section) having the same characteristic frequency is oscillated, the other oscillator (equivalent to the power reception section) begins to swing significantly because of resonance when a small oscillation is transferred thereto.

Although not illustrated, the method relying on resonance in an electric field arranges a dielectric at each of the power supply section (transmitting side) adapted to supply power wirelessly and the power reception section (receiving side) adapted to receive power wirelessly from the power supply section so that electric field resonance occurs between the two dielectrics. It is essential that a dielectric having a dielectric constant from several tens to over 100 (significantly higher than normal) and a small dielectric loss should be used as an antenna and that a given oscillation mode should be excited with the antenna. For example, when a disk antenna is used, the strongest coupling can be achieved when the oscillation mode m=2 or 3 around the disk.

As illustrated in FIG. 5, the method relying on resonance in a magnetic field arranges an LC resonator at each of the power supply section 174 (transmitting side) adapted to supply power wirelessly and the power reception section 278 (receiving side) adapted to receive power wirelessly from the power supply section so that magnetic field resonance occurs between the two LC resonators. For example, part of a loop antenna is formed into the shape of a capacitor so that this capacitor and the inductance of the loop antenna make up an LC resonator. This provides a large Q factor (resonance intensity), thus ensuring that a small proportion of the power is absorbed by components other than the resonance antenna. Therefore, although similar to the electromagnetic induction method in that a magnetic field is used, this method is completely different therefrom in that several kW of power can be transmitted with the power supply section 174 and power reception section 278 spaced from each other more than in the electromagnetic induction method.

In the case of the resonance method, the electromagnetic field wavelength λ, the antenna component size (dielectric disk radius for electric field and loop radius for magnetic field), and the maximum distance (antenna-to-antenna distance D) over which power can be transmitted, are roughly proportional to each other, irrespective of which of the electric and magnetic field resonance phenomena is used. In other words, it is essential that the wavelength λ of the electromagnetic wave at the same frequency as the oscillation frequency, the antenna-to-antenna distance D and the antenna radius r should be maintained more or less constant. Because near field resonance is dealt with, it is also essential that the wavelength λ should be sufficiently larger than the antenna-to-antenna distance D, and that the antenna radius r should not be excessively smaller than the antenna-to-antenna distance D.

Shorter in power transmission distance than the magnetic field counterpart, the electric field resonance method has a large loss due to electromagnetic field in the presence of an obstacle although it is low in heat generation. The magnetic field resonance method remains unaffected by electrostatic capacitance of a dielectric such as human body, offering a small loss due to electromagnetic field and longer power transmission distance than the electric field counterpart. When the electric wave resonance method uses a frequency lower than the millimeter wave band, it is necessary to consider possible interference (EMI) with the signals used by the circuit substrate. On the other hand, when the electric field resonance method uses the millimeter wave band, it is necessary to consider possible interference with the signals transmitted in the millimeter wave band. The magnetic field resonance method basically has small energy leakage in the form of electromagnetic wave. Besides, its wavelength can be set to be different from that of the millimeter wave band. As a result, this method provides full relief from possible interference with the signals used on the circuit board and transmitted in the millimeter wave band.

Although any of the electromagnetic induction, radio wave reception and resonance methods can be basically used, the resonance method relying on resonance in a magnetic field is used in the present embodiment as illustrated in consideration of the characteristics of each method. For example, the electromagnetic induction method has the highest power supply efficiency when the center axes of the primary and secondary coils are aligned. The efficiency declines if the axes are out of alignment. In other words, the positioning accuracy of the primary and secondary coils significantly affects the power transmission efficiency. When the application to an imaging device capable of shake correction is considered as in the present embodiment, the position of the imaging substrate changes relative to the position of the other substrate because of the shake correction function. Therefore, there is a drawback to using the electromagnetic induction method. On the other hand, it is necessary to consider possible EMI (interference) if the radio wave reception method or electric field resonance method is used. However, the magnetic field resonance method provides full relief from these problems.

It should be noted that reference documents (“Cover Story: Power Transmission Available At Last,” Nikkei Electronics 2007 Mar. 26 Issue, Nikkei BP, pp. 98-113 and “Paper: Wireless Power Transmission Technique Developed, Lighting Up 60 W Lamp in Experiment,” Nikkei Electronics 2007 Dec. 3 Issue, Nikkei BP, pp. 117-128) should be referred to for the electromagnetic induction, radio wave reception and resonance methods.

### <Wireless Transmission System: Fifth Embodiment>

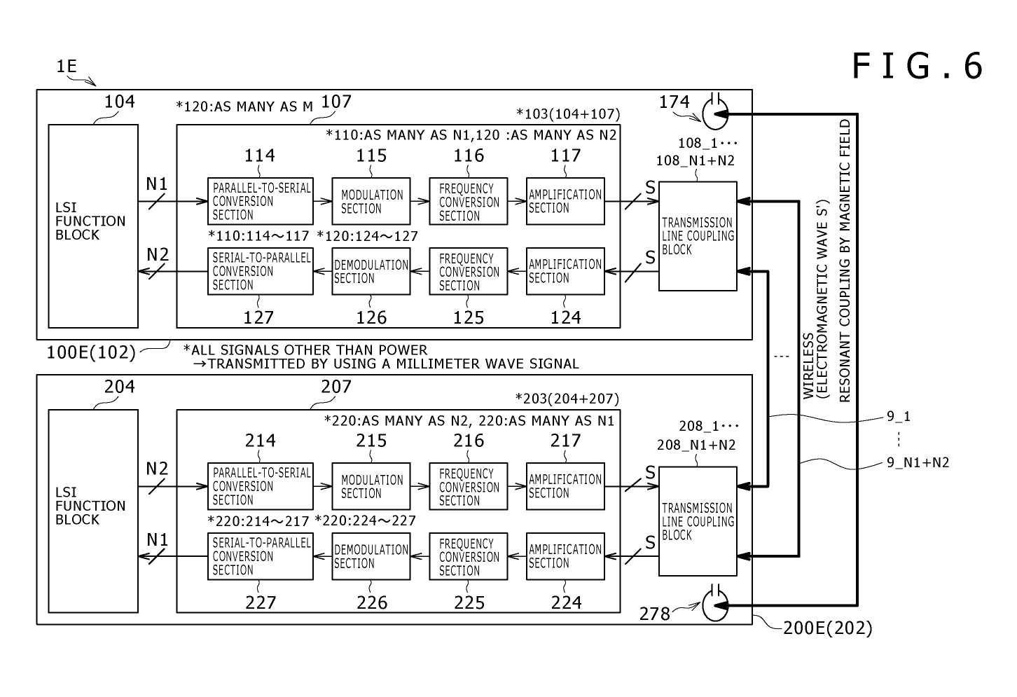

FIG. 6 is a diagram describing a signal interface of a wireless transmission system according to a fifth embodiment. Here, FIG. 6 is a diagram describing the signal interface of a wireless transmission system 1E according to the fifth embodiment in terms of functional configuration. The fifth embodiment is a modification example of the third embodiment.

The fifth embodiment is based on the third embodiment and is further capable of transmitting power wirelessly. That is, a new arrangement is added that is designed to wirelessly supply power to be consumed by the imaging substrate equipped with a second communication device 200E from a first communication device 100E. The arrangement adapted to transmit power wirelessly uses one of the electromagnetic induction, radio wave reception and resonance methods, as described in the fourth embodiment. Here, the magnetic field resonance method is also used as in the fourth embodiment.

The first communication device 100E includes the power supply section 174 adapted to wirelessly supply power to be consumed by the second communication device 200E. The power supply section 174 includes an LC resonator to use the magnetic field resonance method.

The second communication device 200E includes the power reception section 278 adapted to receive power wirelessly from the first communication device 100E. The power reception section 278 includes an LC resonator to use the magnetic field resonance method.

In terms of functional configuration, the fifth embodiment differs from the third embodiment merely in that it has power and signal transmission routes. Therefore, the description of other points of the fifth embodiment is omitted. This method eliminates the need for any interface using electrical wires or terminals, thus providing a system without using any cables.

### <Modulation and Demodulation: First Example>

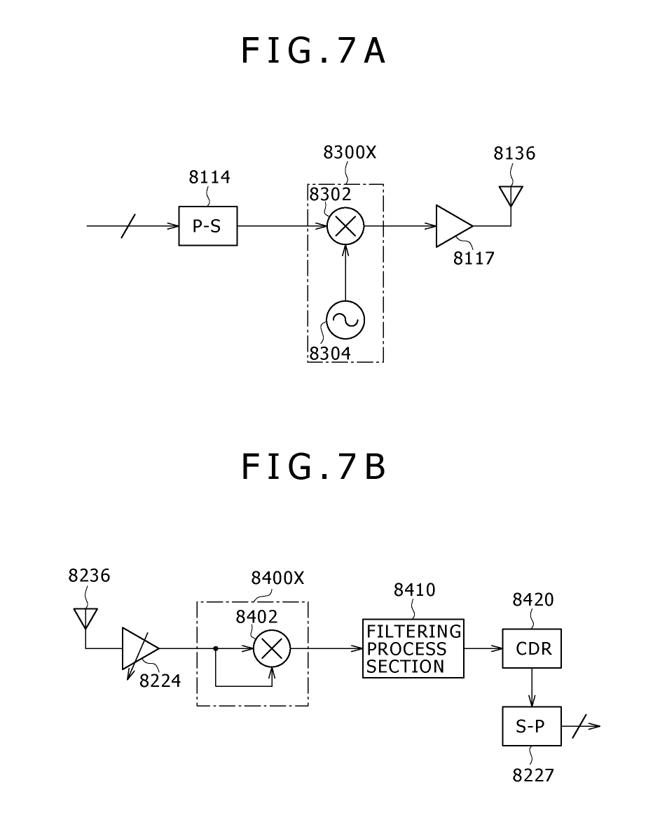

FIGS. 7A and 7B are diagrams describing first examples of modulation and demodulation function sections in a communication process system.

### [Modulation Process Section: First Example]

FIG. 7A illustrates the configuration of a first example of a modulation function section 8300X provided in the transmitting side. A signal to be transmitted (e.g., 12-bit image signal) is converted by the parallel-to-serial conversion section 114 into a high-speed serial data stream which is supplied to the modulation function section 8300X.

The circuit of the modulation function section 8300X may be implemented in various configurations according to the modulation scheme used. When amplitude or phase modulation is used, for example, the modulation function section 8300X need only include a frequency mixing section 8302 and transmitting-side local oscillation section 8304.

The transmitting-side local oscillation section 8304 (first carrier signal generating section) generates a carrier signal (modulation carrier signal) for use in modulation. The frequency mixing section 8302 (first frequency conversion section) multiplies (modulates) the carrier in the millimeter wave band generated by the transmitting-side local oscillation section 8304 by (with) the signal from a parallel-to-serial conversion section 8114 (equivalent to the parallel-to-serial conversion section 114) to generate a modulated signal in the millimeter wave band, supplying the modulated signal to an amplification section 8117 (equivalent to the amplification section 117). The modulated signal is amplified by the amplification section 8117 and emitted from an antenna 8136.

### [Demodulation Function Section: First Example]

FIG. 7B illustrates the configuration of a first example of a demodulation function section 8400X provided in the receiving side. The demodulation function section 8400X may be implemented in various configurations according to the modulation scheme of the transmitting side. Here, a description will be given of the case in which amplitude or phase modulation is used to be consistent with the description of the modulation function section 8300X given above.

The first example of the demodulation function section 8400X includes a two-input frequency mixing section 8402 (mixer circuit) and uses a square detection circuit. The square detection circuit obtains a detection output proportional to the square of the amplitude (of the envelope) of the received millimeter wave signal. It should be noted that a simple envelope detection circuit having no square characteristic may be used rather a square detection circuit. In the illustrated example, a filtering process section 8410, clock regenerating section 8420 (CDR: clock data recovery) and serial-to-parallel conversion section 8227 (S-P: equivalent to the serial-to-parallel conversion section 127) are provided at the subsequent stages of the frequency mixing section 8402. The filtering process section 8410 includes a low-pass filter (LPF).

The millimeter wave signal received by an antenna 8236 is fed to a variable-gain amplification section 8224 (equivalent to the amplification section 224) where the signal is adjusted in amplitude. The resultant signal is supplied to the demodulation function section 8400X. The received signal that has been adjusted in amplitude is simultaneously fed to the two input terminals of the frequency mixing section 8402 to generate a square signal. The square signal is supplied to the filtering process section 8410. The square signal generated by the frequency mixing section 8402 is filtered by a low-pass filter to remove high frequency components, thus generating the input signal waveform (baseband signal) supplied from the transmitting side. The baseband signal is supplied to the clock regenerating section 8420.

The clock regenerating section 8420 (CDR) regenerates a sampling clock based on the baseband signal and samples the baseband signal with the regenerated sampling clock, thus generating a received data stream. The generated received data stream is supplied to the serial-to-parallel conversion section 8227 (S-P) to regenerate a parallel signal (e.g., 12-bit image signal). Of a variety of clock regeneration methods, symbol synchronization is, for example, used.

[Problems with the First Example]

Here, a wireless transmission system including the first examples of the modulation and demodulation function sections 8300X and 8400X have the following drawbacks.

First, the oscillation circuit has the following drawbacks. For example, it is necessary to consider providing multiple channels for outdoor (indoor) communication. In this case, because of the impact of frequency variation component of the carrier, the transmitting-side carrier has to meet stringent stability requirements. If a common method as used for outdoor wireless communication is employed at the transmitting and receiving sides for millimeter wave data transmission during intraenclosure signal transmission or signal transmission between equipment, the carrier has to be stable. As a result, an oscillation circuit is required that can generate a highly stable millimeter wave with a frequency stability of the order of ppm (parts per million).

A possible approach to providing a carrier with high frequency stability would be to provide a highly stable oscillation circuit on a silicon integrated circuit (CMOS: Complementary Metal-oxide Semiconductor). However, common silicon substrates for CMOS are not highly insulating. This makes it difficult to form a tank circuit having a high Q factor. As a result, a carrier with high frequency stability is not easy to achieve. As pointed out in reference document (A. Niknejad, “mm-Wave Silicon Technology 60 GHz and Beyond” (particularly, 3.1.2 Inductors pp. 70-71), ISBN 978-0-387-76558-7), for example, an inductor formed on a CMOS chip has a Q factor of about 30 to 40.

Another possible approach to providing a highly stable oscillation circuit, therefore, would be to form a tank circuit having a high Q factor with a quartz oscillator, for example, outside of the CMOS where the main part of the oscillation circuit is formed. The tank circuit is oscillated at a low frequency, and the oscillation output of the tank circuit is multiplied to increase the frequency thereof to the millimeter wave band. However, it is not preferred to provide such an external tank circuit for all the chips in order to achieve a function adapted to replace the wired signal transmission such as LVDS with that using a millimeter wave signal.

If an amplitude modulation scheme such as OOK (On-Off-Keying) is used, the receiving side need only detect the envelope, thus eliminating the need for an oscillation circuit and providing a reduced number of tank circuits. However, the longer the signal transmission distance, the smaller the reception amplitude. Therefore, when a square detection circuit is used as an example of envelope detection, the impact of reduced reception amplitude becomes conspicuous. As a result, signal distortion has a more adverse impact, making this approach unfavorable. In other words, a square detection circuit is disadvantageous in terms of sensitivity.

Still another possible approach to providing a carrier signal with high frequency stability would be to use a highly stable frequency multiplier and PLL circuit. However, this approach leads to a larger circuit scale. For example, the approach described in reference document (“A 90 nm CMOS Low-Power 60 GHz Transceiver with Integrated Baseband Circuitry,” ISSCC 2009/SESSION 18/RANGING AND Gb/s COMMUNICATION/18.5, 2009 IEEE International Solid-State Circuits Conference, pp. 314-316) uses a push-pull oscillation circuit rather than a 60 GHz oscillation circuit, thus contributing to a smaller circuit scale. Yet this approach still needs a 30 GHz oscillation circuit, frequency divider, phase/frequency detector (PFD), external reference (117 MHz in this example) and so on. Therefore, the circuit scale is obviously large.

A square detection circuit can extract only amplitude components from the received signal. Therefore, the modulation schemes that can be used are limited to amplitude modulation schemes (e.g., ASK such as OOK), making it difficult to use phase or frequency modulation schemes. The fact that it is difficult to use a phase modulation scheme means that the data transmission rate cannot be increased by orthogonalizing the modulated signal.

On the other hand, the approach using a square detection circuit to provide multiple channels through frequency division multiplexing has the following drawbacks. A band-pass filter adapted to select a frequency at the receiving side must be provided at the previous stage of the square detection circuit. However, it is not easy to implement a small and steep low-pass filter. Further, if a steep low-pass filter is used, the transmitting-side carrier has to meet more stringent stability requirements.

### <Modulation and Demodulation: Second Example>

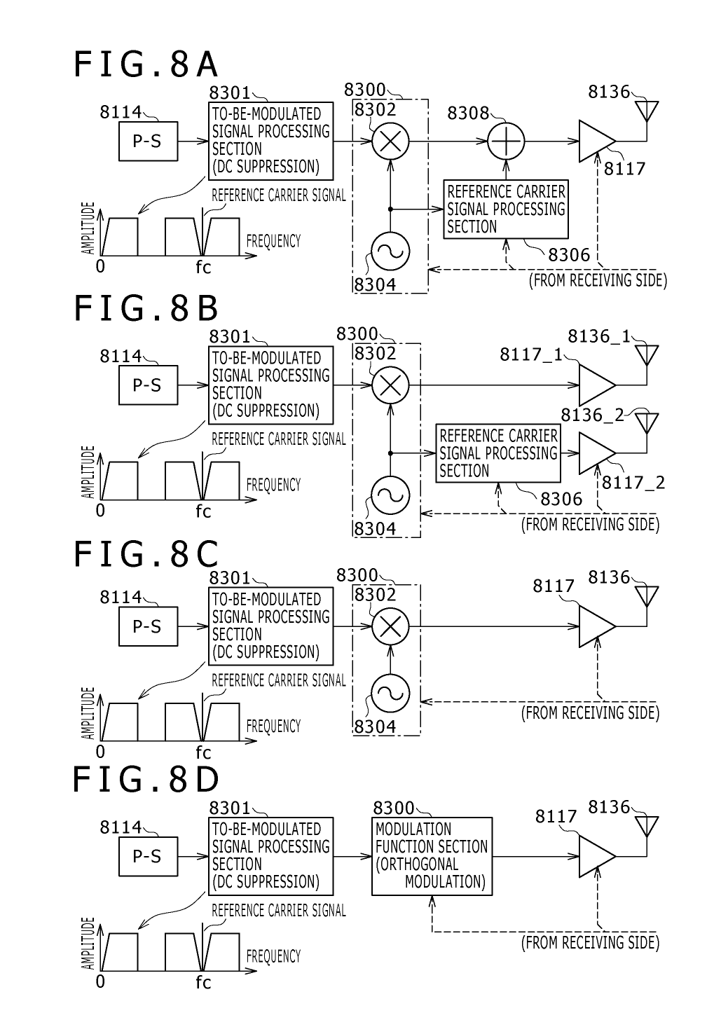

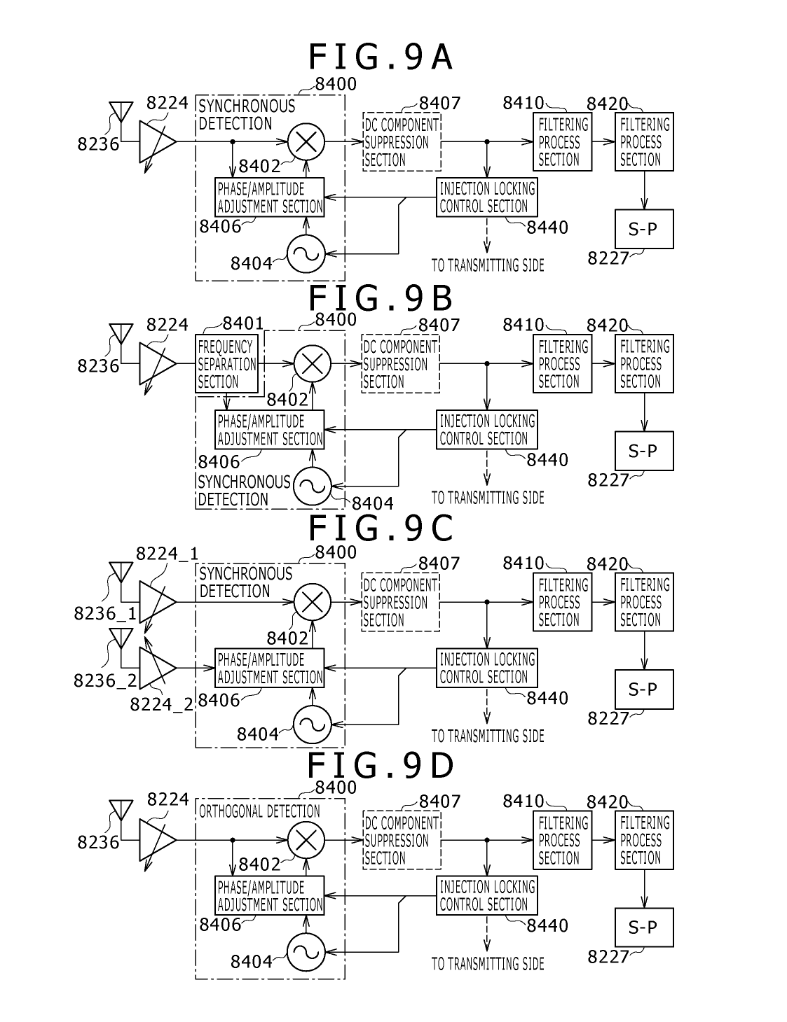

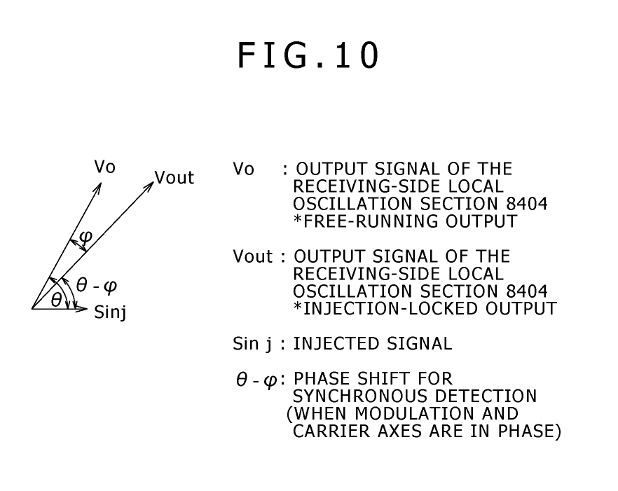

FIGS. 8A to 8D, FIGS. 9A to 9D and FIG. 10 are diagrams describing second examples of modulation and demodulation function sections in a communication process system. FIGS. 8A to 8D are diagrams describing second examples of a transmitting-side signal generating section 8110 (transmitting-side communication section). The same section 8110 includes a modulation function section 8300 (modulation sections 115 and 215 and frequency conversion sections 116 and 216) and its peripheral circuitry. FIGS. 9A to 9D are diagrams describing second examples of a receiving-side signal generating section 8220 (receiving-side communication section). The same section 8220 includes a demodulation function section 8400 (frequency conversion sections 125 and 225 and demodulation sections 126 and 226) and its peripheral circuitry. FIG. 10 is a diagram describing the phase relationship in injection locking.

In order to remedy the problems with the first examples given above, the second examples of the demodulation function section 8400 use injection locking.

In order to use injection locking, a signal to be modulated should preferably be properly corrected in advance so that the signal can be readily injection-locked at the receiving side. Typically, low frequency components near DC of the signal to be modulated should be suppressed before modulation. That is, modulating a signal after suppressing its low frequency components including DC minimizes the modulated signal components near a carrier frequency fc, thus making the injection locking easy at the receiving side. In the case of a digital scheme, DC free coding is performed, for example, to ensure that no DC component occurs as a result of a succession of the same code.

Further, it is preferred that a reference carrier signal should be transmitted together with the signal modulated into a millimeter wave band signal (modulated signal). The reference carrier signal is used as a reference for injection locking at the receiving side and is equivalent to the carrier signal used for modulation. Equivalent to the carrier signal output from the transmitting-side local oscillation section 8304 and used for modulation, the reference carrier signal has an always constant (unchanged) frequency and phase (more preferably amplitude too). Typically, this signal is the carrier signal used for modulation itself, but not limited thereto and may be a signal that is at least synchronous with the carrier signal. For example, this signal may be a signal at a different frequency that is synchronous with the carrier signal used for modulation (e.g., harmonic signal) or a signal that is at the same frequency but at a different phase from the carrier signal used for modulation (e.g., orthogonal carrier signal that is orthogonal to the carrier signal used for modulation).

Depending on the modulation scheme and modulation circuit, the carrier signal may be contained in the output signal of the modulation circuit (e.g., standard amplitude modulation and ASK), or may be suppressed (e.g., carrier suppressed amplitude modulation, ASK and PSK). Therefore, the circuit adapted to transmit the reference carrier signal from the transmitting side together with the signal modulated into a millimeter wave band signal is configured according to the reference carrier signal type (whether or not the carrier signal, used for modulation, is used as the reference carrier signal), modulation scheme and modulation circuit.

### [Modulation Function Section: Second Example]

FIGS. 8A to 8D illustrate second examples of the modulation function section 8300 and its peripheral circuitry. A to-be-modulated signal processing section 8301 is provided at the previous stage of the modulation function section 8300 (frequency mixing section 8302). FIGS. 8A to 8D illustrate configuration examples for a digital scheme. Therefore, the to-be-modulated signal processing section 8301 subjects the data supplied from the parallel-to-serial conversion section 8114 to DC-free coding such as 8-9 conversion coding (8B/9B coding), 8-10 conversion coding (8B/10B coding) or scrambling. Although not illustrated, the signal to be modulated should be high-pass-filtered (or band-pass-filtered) when an analog modulation scheme is used.

The 8-10 conversion coding converts eight-bit data into a 10-bit code. For example, of the 1024 possible 10-bit codes, those with preferably the same numbers of 1s and 0s are selected for use in a data code to provide DC-free codes. Part of the 10-bit codes that are not used as data codes are employed as special codes to represent, for example, idle symbols and packet delimiters. For scrambling, 64B/66B coding is, for example, known which is used for the 10GBase-X family (e.g., IEEE802.3ae).

Here, basic configuration 1 shown in FIG. 8A includes a reference carrier signal processing section 8306 and signal combining section 8308 so as to combine (mix) the output signal (modulated signal) of the modulation circuit (first frequency conversion section) and the reference carrier signal together. It can be said that this configuration is universal and not dependent on the reference carrier signal type or modulation scheme. It should be noted, however, that, depending on the phase of the reference carrier signal, the combined reference carrier signal may be detected as a DC offset component during demodulation at the receiving side, adversely affecting the reproducibility of the baseband signal. In this case, a countermeasure is provided at the receiving side to suppress the DC component. In other words, a reference carrier signal should be used that has a proper phase relationship so that there is no need to remove the DC offset component during demodulation.

The reference carrier signal processing section 8306 adjusts, as necessary, the phase or amplitude of the modulated carrier signal supplied from the transmitting-side local oscillation section 8304. The output signal of the same section 8306 is supplied to the signal combining section 8308 as a reference carrier signal. This basic configuration 1 is essentially used, for example, when the output signal of the frequency mixing section 8302 has an always constant (unchanged) frequency or phase and does not contain any carrier signal (frequency or phase modulation schemes) and when a harmonic signal or orthogonal carrier signal of the carrier signal used for modulation is used as a reference carrier signal.

In this case, a harmonic signal or orthogonal carrier signal of the carrier signal used for modulation can used as a reference carrier signal. In addition, the amplitudes and phases of the modulated signal and reference carrier signal can be adjusted independently. That is, the amplification section 8117 adjusts the gain with emphasis on the amplitude of the modulated signal. At this time, the amplitude of the reference carrier signal is adjusted at the same time. In order to provide a favorable amplitude for injection locking, however, the reference carrier signal processing section 8306 may adjust only the amplitude of the reference carrier signal.

It should be noted that although, in basic configuration 1, the signal combining section 8308 is provided to combine the modulated signal and reference carrier signal together, this is not absolutely necessary. Instead, the modulated signal and reference carrier signal may be transmitted to the receiving side using different antennas 8136_1 and 8136_2 via the different millimeter wave signal transmission lines 9 preferably to prevent interference as illustrated in basic configuration 2 of FIG. 8B. Basic configuration 2 can transmit a reference carrier signal also having a constant amplitude to the receiving side, making it the optimal choice in terms of ease of injection locking.

Basic configurations 1 and 2 are advantageous in that the carrier signal used for modulation (in other words, modulated signal to be transmitted) and the reference carrier signal can be adjusted in amplitude and phase independently of each other. It can be said, therefore, that these configurations are suitable for rendering the modulation axis carrying information to be transmitted out of phase with the axis of the reference carrier signal used for injection locking (reference carrier axis) so as to ensure that no DC offset occurs in the demodulated output.

When the output signal itself of the frequency mixing section 8302 contains a carrier signal having an always constant frequency or phase, the transmitting-side signal generating section 8110 may take on basic configuration 3 shown in FIG. 8C that is devoid of the reference carrier signal processing section 8306 and signal combining section 8308. In this configuration, it is only necessary to transmit only the signal modulated into the millimeter wave band by the frequency mixing section 8302 to the receiving side and treat the carrier signal contained in the modulated signal as a reference carrier signal. Therefore, there is no need to add a different reference carrier signal to the output signal of the frequency mixing section 8302 for transmission to the receiving side. For example, when an amplitude modulation scheme (e.g., ASK) is used, configuration 3 may be employed. At this time, a DC elimination process should preferably be performed.

It should be noted, however, that even when amplitude modulation or ASK is used, a carrier suppressing circuit (e.g., balanced modulation circuit or double balanced modulation circuit) may be actively used as the frequency mixing section 8302 so that a reference carrier signal is transmitted together with the output signal of the frequency mixing section 8302 as in basic configurations 1 and 2.

It should be noted that even when a phase or frequency modulation scheme is used, only the signal modulated into the millimeter wave band (frequency-converted modulated signal) by the modulation function section 8300 (using, for example, orthogonal modulation) as in basic configuration 4 shown in FIG. 8D may be transmitted. However, factors such as injection level (amplitude level of the reference carrier signal fed to the injection-locked oscillation circuit), modulation scheme, data rate and carrier frequency are also in play as to whether injection locking can be achieved at the receiving side, making this option limited in application.

Any of basic configurations 1 to 4 can adopt an arrangement to receive, from the receiving side, information based on the injection locking result obtained at the receiving side to adjust the frequency of the modulated carrier signal, the millimeter wave (particularly, that used as an injection signal at the receiving side such as reference carrier signal or modulated signal) or the phase of the reference carrier signal, as indicated by the dashed lines in the figures. It is not absolutely necessary to transmit information from the receiving side to the transmitting side using a millimeter wave signal. A desired scheme, whether wired or wireless, may be used.

Any of basic configurations 1 to 4 adjusts the frequency of the modulated carrier signal (or reference carrier signal) by controlling the transmitting-side local oscillation section 8304.

In basic configurations 1 and 2, the amplitude or phase of the reference carrier signal is adjusted by controlling the reference carrier signal processing section 8306 or amplification section 8117. It should be noted that the amplification section 8117 adapted to adjust the transmission power may be used to adjust the amplitude of the reference carrier signal in basic configuration 1. In this case, however, there is a drawback in that the amplitude of the modulated signal is also adjusted.

In basic configuration 3 that is suitable for an amplitude modulation scheme (analog amplitude modulation or digital ASK), the carrier frequency component (equivalent to the amplitude of the reference carrier signal) of the modulated signal is adjusted by adjusting the DC component of the signal to be modulated or controlling the modulation degree (modulation ratio). We consider, for example, the modulation of a signal that is the sum of a signal to be transmitted and a DC component. In this case, in order to maintain the modulation degree constant, the amplitude of the reference carrier signal is adjusted by controlling the DC component. In order to maintain the DC component constant, on the other hand, the amplitude of the reference carrier signal is adjusted by controlling the modulation degree.

In this case, however, there is no need to use the signal combining section 8308. Transmission of the modulated signal output from the frequency mixing section 8302 to the receiving side allows for the modulated signal and the carrier signal used for modulation to be automatically mixed for transmission. The modulated signal is obtained as a result of the modulation of the carrier signal by the signal to be transmitted. Inevitably, the reference carrier signal is carried by the same axis as the modulation axis carrying the signal to be transmitted of the modulated signal (i.e., carried by the axis that is in phase with the modulation axis). At the receiving side, the carrier frequency component in the modulated signal is used as a reference carrier signal for injection locking. Here, although a detailed description will be given later, when considered in terms of a phase plane, the modulation axis carrying information to be transmitted and the axis of the carrier frequency component (reference carrier signal) used for injection locking are in phase, resulting in a DC offset in the demodulated output caused by the carrier frequency component (reference carrier signal).

### [Demodulation Function Section: Second Example]

FIGS. 9A to 9D illustrate second examples of the demodulation function section 8400 and its peripheral circuitry. The demodulation function section 8400 according to the present embodiment includes a receiving-side local oscillation section 8404 and supplies an injection signal to the same section 8404 to obtain an output signal associated with the carrier signal used for modulation at the transmitting side. Typically, the demodulation function section 8400 obtains an oscillation output signal synchronous with the carrier signal used at the transmitting side. Then, the demodulation function section 8400 multiplies (synchronously detects) a demodulation carrier signal (referred to as a reproduced carrier signal) using the frequency mixing section 8402, thus providing a synchronously detected signal. The reproduced carrier signal is based on the received millimeter wave modulated signal and the output signal of the receiving-side local oscillation section 8404. This synchronously detected signal provides waveform of the input signal (baseband signal) transmitted from the transmitting side when the high frequency components are removed therefrom by the filtering section 8410. The rest is the same as in the first example.

The frequency mixing section 8402 has advantages including excellent bit error rate, for example, as a result of frequency conversion (down-conversion or demodulation) by synchronous detection and applicability of phase and frequency modulation as a result of development into orthogonal detection.

In supplying a reproduced carrier signal based on the output signal of the receiving-side local oscillation section 8404 to the frequency mixing section 8402 for demodulation, phase shift must be considered. It is essential to provide a phase adjustment circuit in the synchronous detection system. The reason for this is that, as pointed out, for example, in reference document (L. J. Paciorek, “Injection Lock of Oscillators,” Proceeding of the IEEE, Vol. 55 NO. 11, November 1965, pp. 1723-1728), there is a phase difference between the received modulated signal and the oscillation output signal output from the receiving-side local oscillation section 8404 as a result of injection locking.

In this example, a phase/amplitude adjustment section 8406 is provided in the demodulation function section 8400. The same section 8406 is capable of adjusting not only the phase but also the injection amplitude. The phase adjustment circuit may be provided either for the signal injected into the receiving-side local oscillation section 8404 or the output signal of the same section 8404. Alternatively, the phase adjustment circuit may be used for both signals. The receiving-side local oscillation section 8404 and phase/amplitude adjustment section 8406 make up a demodulating-side (second) carrier signal generating section adapted to generate a demodulated carrier signal synchronous with the modulated carrier signal and supply the demodulated carrier signal to the frequency mixing section 8402.

As indicated by the dashed lines in the figures, a DC component suppression section 8407 is provided at the subsequent stage of the frequency mixing section 8402 to remove a DC offset component that may be contained in the synchronously detected signal according to the phase of the reference carrier signal combined with the modulated signal (more specifically, when the modulated signal and reference carrier signal are in phase).

Here, letting the free-running oscillation frequency of the receiving-side local oscillation section 8404 be denoted by fo (ωo), the center frequency of the injected signal (frequency in the case of the reference carrier signal) by fi (ωi), the voltage injected into the receiving-side local oscillation section 8404 by Vi, the free-running oscillation voltage of the receiving-side local oscillation section 8404 by Vo and the Q factor (quality factor) by Q based on reference document by L. J. Paciorek, the lock range, represented by a maximum pull-in frequency range Δfomax, is given by Equation (A). It is clear from Equation (A) that the Q factor is affected by the lock range and that the smaller the Q factor, the wider the lock range.

Δfomax=fo/(2*Q)*(Vi/Vo)*1/sqrt(1−(Vi/Vo)̂2) (A)

It can be understood from Equation (A) that the receiving-side local oscillation section 8404 has a band-pass effect because it can be locked to (synchronized with) a component falling within Δfomax of the injected signal but cannot be locked to a component falling outside Δfomax. For example, if a modulated signal having a frequency band is supplied to the receiving-side local oscillation section 8404 to obtain an oscillation output signal through injection locking, an oscillation output signal synchronous with the mean frequency of the modulated signal (frequency of the carrier signal) is obtained. At this time, the components falling outside Δfomax are removed.

Here, a possible approach to supplying an injection signal to the receiving-side local oscillation section 8404 would be to supply the received millimeter wave signal to the same section 8404 as an injection signal as illustrated in basic configuration 1 of FIG. 9A. In this case, it is not preferred that the frequency band of the modulated signal should exist within Δfomax. That is, frequency components undesired for injection locking may be supplied to the receiving-side local oscillation section 8404, possibly making the injection locking difficult to achieve. However, if the low frequency components of the signal to be modulated are suppressed (e.g., by DC free coding) in advance at the transmitting side, thereby preventing the modulated signal components from existing near the carrier frequency, there is no problem in adopting basic configuration 1.

Another possible approach would be to provide a frequency separation section 8401 as in basic configuration 2 shown in FIG. 9B so as to separate the received millimeter wave signal into the modulated signal and reference carrier signal and supply the separated reference carrier signal component to the receiving-side local oscillation section 8404 as an injection signal. Injection locking is easy to achieve because frequency components undesired for injection locking are suppressed before the reference carrier signal component is supplied.

Basic configuration 3 shown in FIG. 9C is appropriate when basic configuration 2 shown in FIG. 8B is used at the transmitting side. This scheme is designed to receive the modulated signal and reference carrier signal with different antennas 8236_1 and 8236_2 via the different millimeter wave signal transmission lines 9 preferably to prevent interference. It can be said that basic configuration 3 of the receiving side is the optimal choice in terms of ease of injection locking because a reference carrier signal having an always constant amplitude can also be supplied to the receiving-side local oscillation section 8404.

Basic configuration 4 shown in FIG. 9D is appropriate when basic configuration 4 shown in FIG. 8D is used at the transmitting side in conjunction with a phase or frequency modulation scheme. Basic configuration 4 is similar in configuration to basic configuration 1. Practically, however, the demodulation function section 8400 includes a demodulation circuit such as orthogonal detection circuit capable of handling phase or frequency modulation.

The millimeter wave signal received by the antenna 8236 is supplied to the frequency mixing section 8402 and receiving-side local oscillation section 8404 by a divider (separator) that is not illustrated. When injection locking is successful, the receiving-side local oscillation section 8404 outputs a reproduced carrier signal that is synchronous with the carrier signal used for modulation at the transmitting side.

Here, factors such as injection level (amplitude level of the reference carrier signal fed to the injection-locked oscillation circuit), modulation scheme, data rate and carrier frequency are also in play as to whether injection locking can be achieved at the receiving side (the reproduced carrier signal that is synchronous with the carrier signal used for modulation at the transmitting side can be obtained). Further, it is essential that the modulated signal should fall outside the band in which injection locking can be achieved. For this reason, it is preferred that DC free coding should be performed at the transmitting side so as to ensure that the center (mean) frequency of the modulated signal is roughly equal to the carrier frequency and that the center (mean) phase thereof is roughly equal to zero (origin on the phase plane).

For example, reference document (P. Edmonson, et al., “Injection Locking Techniques for a 1-GHz Digital Receiver Using Acoustic-Wave Devices,” IEEE Transactions on Ultrasonics, Ferroelectrics, and Frequency Control, Vol. 39, No. 5, September, 1992, pp. 631-637) discloses a case in which a signal modulated by BPSK (Binary Phase Shift Keying) is used as an injection signal. In BPSK, the injection signal to be injected into the receiving-side local oscillation section 8404 undergoes a 180-degree phase change according to a symbol time T of the input signal. Even in this case, letting the maximum pull-in frequency range of the receiving-side local oscillation section 8404 be denoted by Δfomax, the symbol time T must satisfy T>1/(2Δfomax) in order for the receiving-side local oscillation section 8404 to achieve injection locking. This means that the symbol time T must be set short with a sufficient margin. The fact that the short symbol time T is favorable means that the data rate should be increased, which is convenient for applications intended for high-speed data transfer.

On the other hand, reference document (Tarar, M. A.; Zhizhang Chen, “A Direct Down-Conversion Receiver for Coherent Extraction of Digital Baseband Signals Using the Injection Locked Oscillators,” Radio and Wireless Symposium, 2008 IEEE, Volume, Issue, 22-24 Jan. 2008, pp. 57-60) discloses a case in which a signal modulated by 8PSK (8-Phase Shift Keying) is used as an injection signal. This reference document also points out that, assuming that the injected voltage and carrier frequency are the same, the higher the data rate, the easier it is to achieve injection locking, which is also convenient for applications intended for high-speed data transfer.

In any of basic configurations 1 to 4, the injected voltage Vi and free-running oscillation frequency fo are controlled based on Equation (A) to control the lock range. In other words, it is essential that the injected voltage Vi and free-running oscillation frequency fo should be adjusted to achieve injection locking. For example, an injection locking control section 8440 is provided at the subsequent stage of the frequency mixing section 8402 (at the subsequent stage of the DC component suppression section 8407 in the example shown in the figures). The injection locking control section 8440 determines, based on the synchronous detection signal (baseband signal) obtained by the frequency mixing section 8402, the state of injection locking and controls the respective sections to be adjusted based on the determination result so as to achieve injection locking.

At this time, either or both of two countermeasures, one taken at the receiving side, and another taken at the transmitting side by supplying information contributing to control (e.g., not only control information but also detection signals that are the source of control information) to the transmitting side (as shown by alternate long and short dash line in the figures), may be taken. The countermeasure taken at the receiving side results in the receiving side failing to achieve injection locking unless a millimeter wave signal (reference carrier signal component in particular) is transmitted at a given intensity. Therefore, this countermeasure is advantageous in that it can be taken at the receiving side alone although it has drawbacks in terms of power consumption and interference resistance.

In contrast, the countermeasure taken at the transmitting side requires data transmission from the receiving side to the transmitting side. However, this countermeasure is advantageous in that it permits transmission of a millimeter wave signal at the smallest possible power level at which injection locking can be achieved at the receiving side for reduced power consumption and also in that it provides improved interference resistance.

Using injection locking in intraenclosure signal transmission or signal transmission between equipment provides the following advantages. That is, the transmitting-side local oscillation section 8304 can relieve the frequency stability requirements imposed on the carrier signal used for modulation. The receiving-side local oscillation section 8404 adapted to achieve injection locking must have a low Q factor to be able to respond to the variations in frequency of the transmitting side, as is clear from Equation (A).

This is convenient when the receiving-side local oscillation section 8404 as a whole including a tank circuit (inductive and capacitive components) is formed on a CMOS. The receiving-side local oscillation section 8404 at the receiving side may have a low Q factor. The same is true for the transmitting-side local oscillation section 8304 at the transmitting side in this respect. The same section 8304 may be low in frequency stability and have a low Q factor.

CMOS devices will continue to be scaled down in dimensions in the future, further pushing up their operating frequencies. In order to implement a small-size transmission system in a higher frequency band, a higher carrier frequency should preferably be used. The injection locking scheme in the present example can relieve the frequency stability requirements, thus making it possible to use a carrier signal at a higher frequency with ease.

The fact that the carrier frequency may be low in frequency stability, despite being high, (in other words, may have a low Q factor) means that there is no need to use a highly stable frequency multiplier to provide a high-frequency and highly stable carrier signal or a highly stable PLL circuit for carrier synchronization. As a result, a communication function can be achieved in a compact manner with a small circuit scale even when a higher frequency carrier signal is used.

Because the receiving-side local oscillation section 8404 obtains a reproduced carrier signal synchronous with the carrier signal used at the transmitting side and supplies the reproduced carrier signal to the frequency mixing section 8402 for synchronous detection, there is no need to provide any band-pass filter at the previous stage of the frequency mixing section 8402. The selection of a received frequency can be virtually accomplished by controlling the transmitting- and receiving-side local oscillators in complete synchronism with each other (i.e., so that injection locking can be achieved), making the selection of the received frequency easy. The millimeter wave band requires less time for injection locking than lower frequencies, making it possible to complete the received frequency selection in a shorter time.

Because the transmitting- and receiving-side local oscillators are in complete synchronism with each other, the component of transmitting-side carrier frequency variation is cancelled out, permitting easy application of various modulation schemes such as phase modulation. As for digital modulation, for example, phase modulation schemes such as QPSK (Quadrature Phase Shift Keying) and 16QAM (Quadrature Amplitude Modulation) are known. These modulation schemes are designed to orthogonally modulate a carrier wave by a baseband signal. In orthogonal modulation, input data is separated into I- and Q-phase baseband signals for orthogonal modulation. That is, the I- and Q-axis carrier signals are modulated separately by the I- and Q-phase signals. Injection locking can be used not only in 8PSK modulation as described in reference document by Tarar, M. A. but also in orthogonal modulation schemes such as QPSK and 16QAM, providing higher data transmission rate through orthogonalization of the modulated signal.

Injection locking, if used in combination with synchronous detection, provides interference immunity without using any band-pass filter for wavelength selection at the receiving side even when a plurality of transmitting and receiving pairs engage in simultaneous and independent transmission as in the case of providing multiple channels or achieving full duplex bidirectional transmission.

### [Relationship Between Injection Signal and Oscillation Output Signal]

FIG. 10 is a diagram describing the phase relationship between the different signals in injection locking. Here, a case is shown as a basic example in which the injection signal (reference carrier signal in this case) is in phase with the carrier signal used for modulation.

The receiving-side local oscillation section 8404 can operate in one of two modes, i.e., injection locking mode and amplifier mode. When injection locking is used, the same section 8404 is basically used in injection locking mode, and in amplifier mode in a special case. The term “special case” refers to a case in which the carrier signal used for modulation is out of phase with the reference carrier signal (typically the two signals are orthogonal to each other) when the reference carrier signal is used as an injection signal.

When the receiving-side local oscillation section 8404 operates in injection locking mode, there is a phase difference between a received reference carrier signal SQ and an oscillation output signal SC output from the receiving-side local oscillation section 8404 as a result of injection locking. In order for the frequency mixing section 8402 to perform orthogonal detection, this phase difference must be corrected. As is clear from the figure, the phase shift θ-φ must be adjusted by the phase/amplitude adjustment section 8406 to bring the output signal of the receiving-side local oscillation section 8404 roughly in phase with a modulated signal SI.

In other words, the phase/amplitude adjustment section 8406 need only shift the phase so that the phase difference θ-φ is cancelled out between an output signal Vout during operation of the receiving-side local oscillation section 8404 in injection locking mode and a signal Sinj injected into the same section 8404. Incidentally, the phase difference between the signal Sinj injected into the receiving-side local oscillation section 8404 and a free-running output Vo of the same section 8404 is θ, and that between the output signal Vout during injection locking and the free-running output Vo of the same section 8404 φ.

### <Relationship Between Provision of Multiple Channels and Injection Locking>

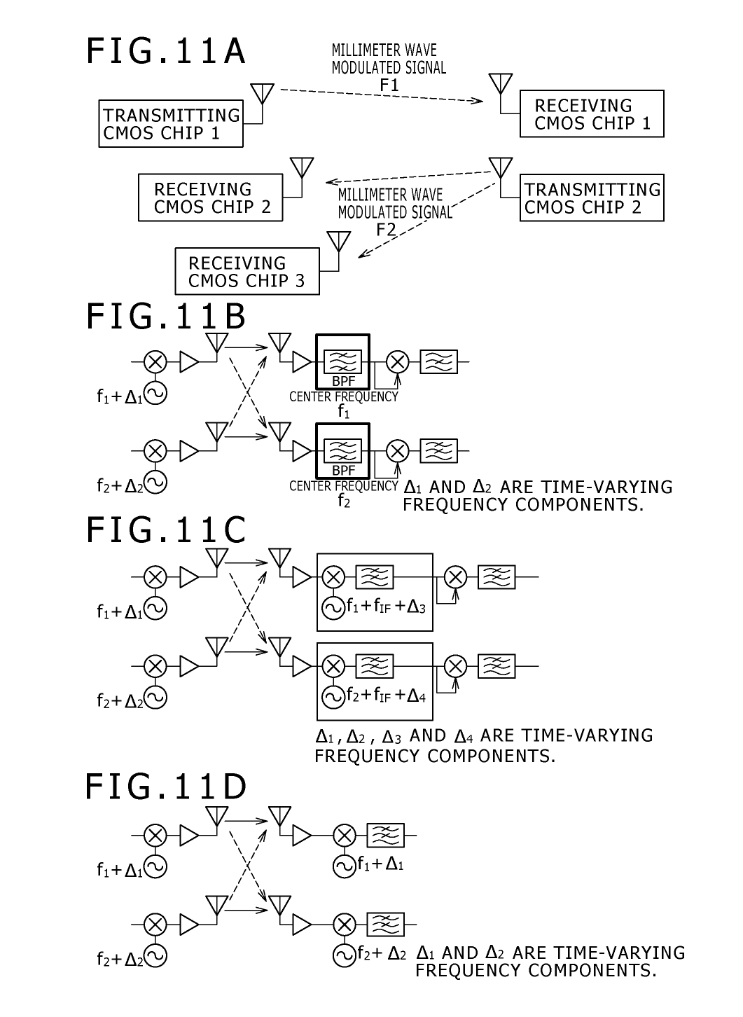

FIGS. 11A to 11D are diagrams describing the relationship between provision of multiple channels and injection locking. As illustrated in FIG. 11A, multiple channels can be provided if different transmitting and receiving pairs use different carrier frequencies. That is, multiple channels can be provided by frequency division multiplexing. Full duplex bidirectional transmission can be readily achieved by using different carrier frequencies, making it possible for a plurality of semiconductor chips (i.e., transmitting-side signal generating sections 110 and receiving-side signal generating sections 220) to communicate independently in the imaging device enclosure.

We assume, for example, that two transmitting and receiving pairs engage in simultaneous and independent transmission as illustrated in FIGS. 11B to 11D. Here, if square detection is used as illustrated in FIG. 11B, a band-pass filter (BPF) is required as described earlier for frequency selection so as to provide multiple channels using frequency multiplexing. It is not easy to implement a small and steep band-pass filter. In order to change selected frequencies, a variable band-pass filter is required. Because transmission is affected by time-varying frequency components (frequency variation components Δ) at the transmitting side, only those modulation schemes can be selected that permit the impact of the frequency variation components Δ to be ignored (e.g., OOK), making it difficult to provide higher data transmission rate through orthogonalization of the modulated signal.

If no carrier synchronization PLL is provided at the receiving side for downsizing purposes, a possible approach would be to down-convert the frequency to IF (Intermediate Frequency) for square detection as shown in FIG. 11C. In this case, it is possible to select a signal to be received without any band-pass filter by adding a block adapted to convert the frequency to a sufficiently high IF. This approach, however, leads to a more complex circuit. Transmission is affected not only by the frequency variation components Δ at the transmitting side but also time-varying frequency components (frequency variation components Δ) produced by down-conversion at the receiving side. As a result, only those modulation schemes can be selected that permit amplitude information to be extracted in such a manner that the impact of the frequency variation components Δ can be ignored (e.g., ASK or OOK).

In contrast, injection locking brings the transmitting-side local oscillation section 8304 and receiving-side local oscillation section 8404 in complete synchronism with each other as illustrated in FIG. 11D, thus making it possible to use a variety of modulation schemes with ease. No carrier synchronization PLL is required, downsizing the circuit scale and allowing for ready selection of received frequencies. In addition, a millimeter wave band oscillation circuit can be implemented with a tank circuit having a smaller time constant than at low frequencies. This requires a shorter time for injection locking than at low frequencies, making this approach fit for high-speed transmission. As described above, injection locking readily speeds up the transmission as compared to common transmission of baseband signals between chips, thus providing reduced number of I/O terminals. Further, small-size millimeter wave antenna can be formed on the chip, thus offering a significantly high degree of freedom in how to extract signals from the chip. Still further, injection locking cancels out the frequency variation components Δ at the transmitting side, allowing for selection of a variety of modulation schemes such as phase modulation (e.g., orthogonal modulation).

Even when multiple channels are provided by frequency division multiplexing, the original transmitted signal can be restored without being affected by possible frequency variations Δ in the carrier signal (without being affected by so-called interference) by regenerating, at the receiving side, a signal synchronous with the carrier signal used for modulation at the transmitting side and frequency-converting this signal through synchronous detection. This eliminates the need for providing a band-pass filter as a frequency selection filter at the previous stage of the frequency conversion circuit (down-converter) as illustrated in FIG. 11D.

### <Millimeter Wave Transmission Structure: First Example>

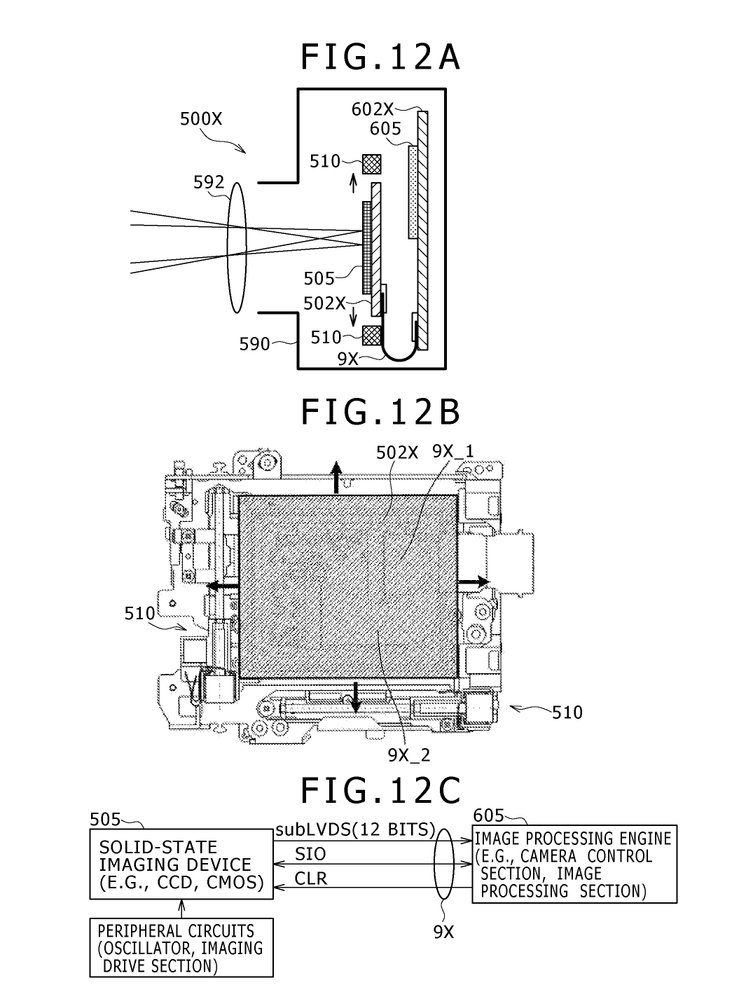

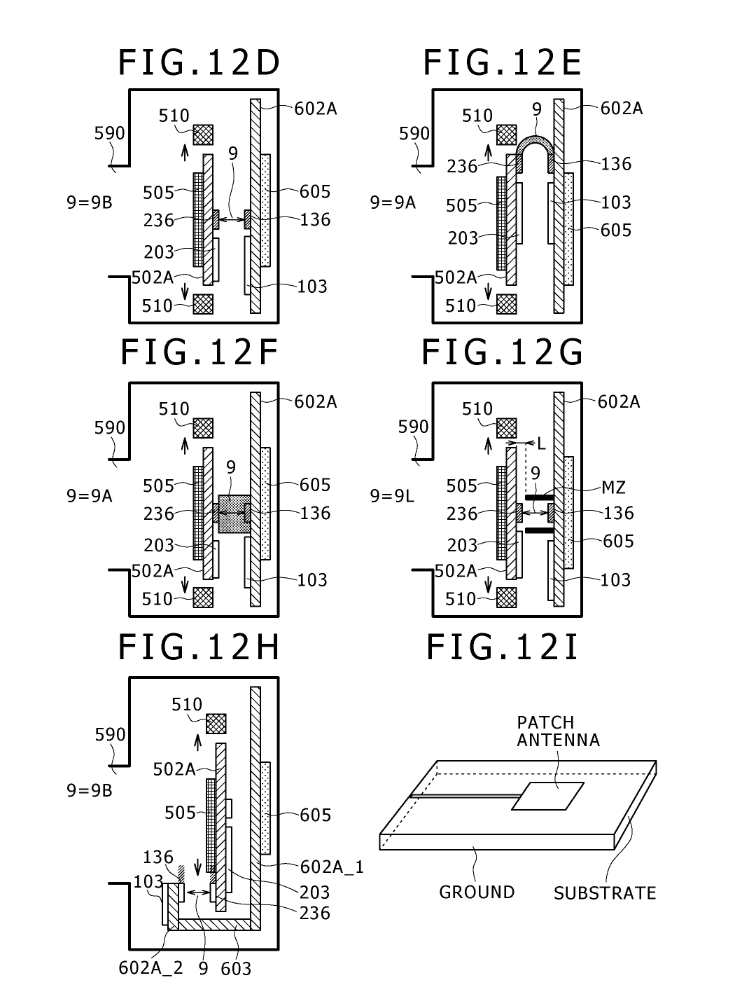

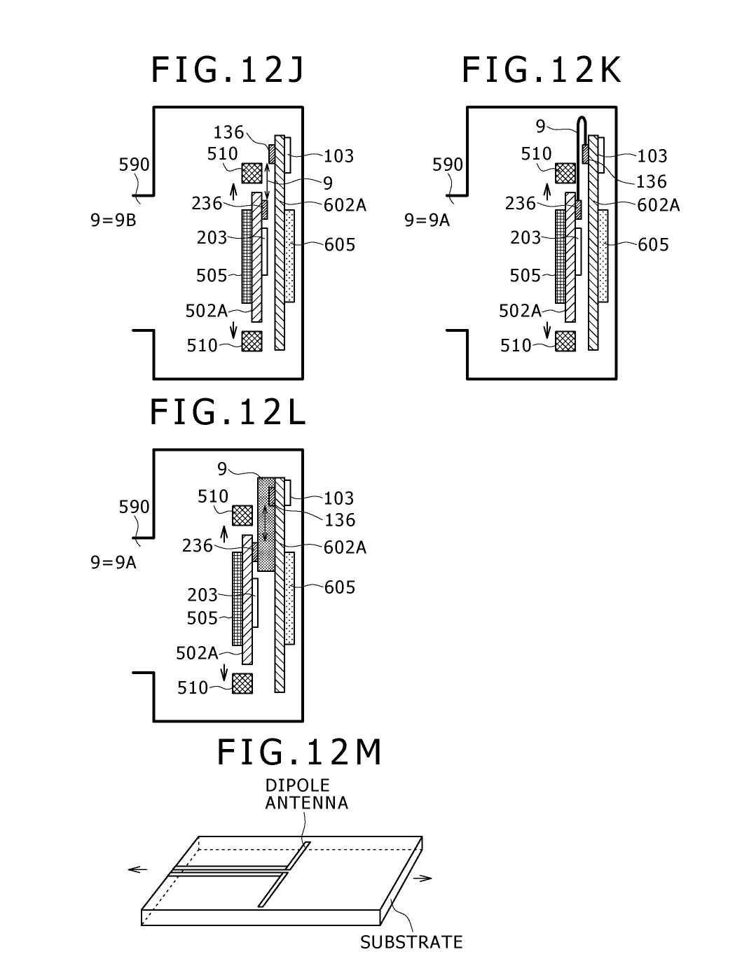

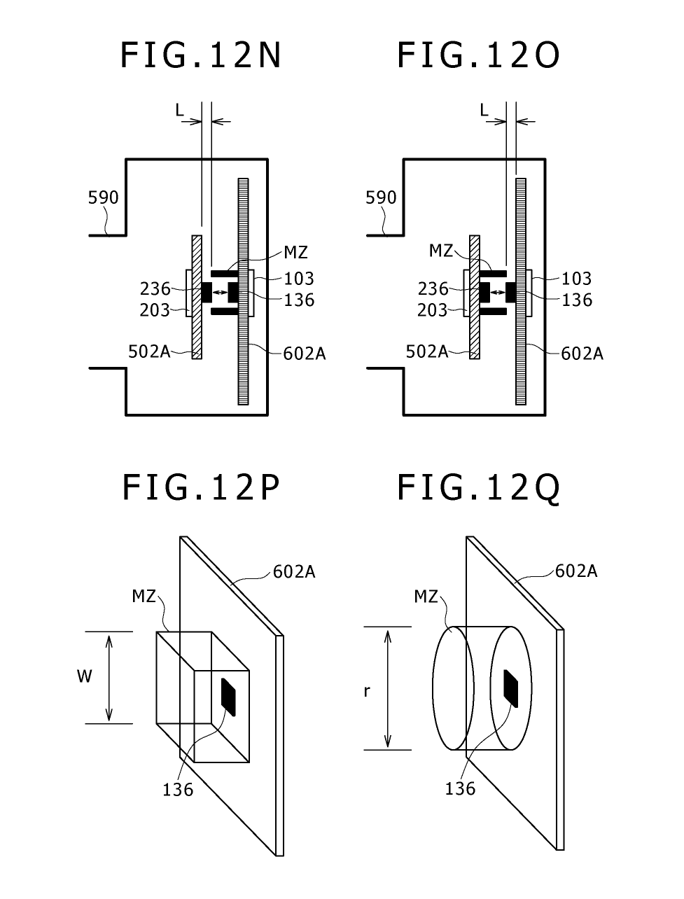

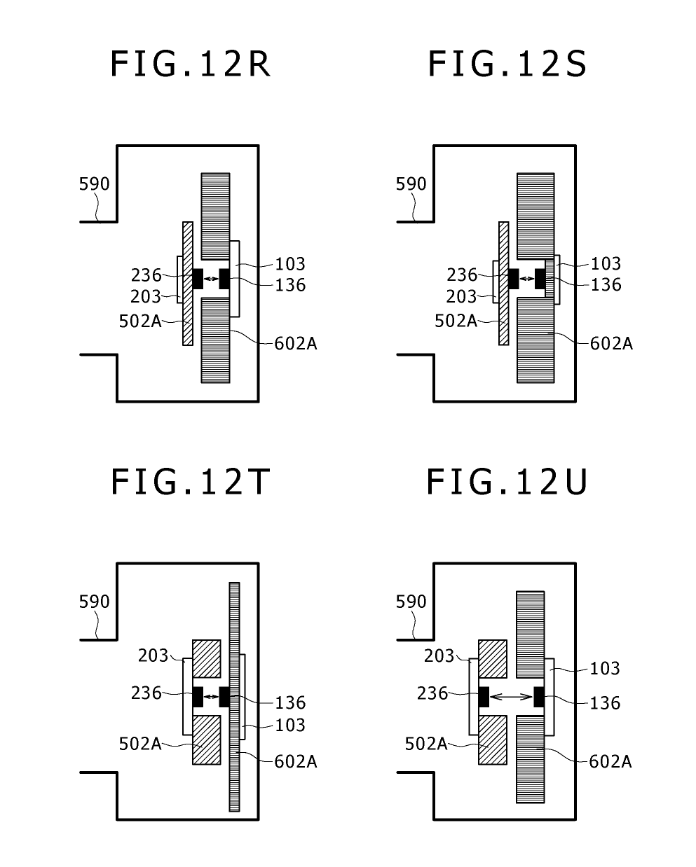

FIGS. 12A to 12U are diagrams describing a first example of a millimeter wave transmission structure according to the present embodiment. Here, FIGS. 12A to 12C illustrate a comparative example, and FIGS. 12D to 12U illustrate a millimeter wave transmission structure of the first example.

The first example is an application example of a millimeter wave transmission structure for achieving the functions of the wireless transmission systems 1A, 1B and 1D according to the first, second and fourth embodiments. In particular, this example is an example of application to an imaging device capable of shake correction by moving its solid-state imaging device. In this example, an imaging substrate 502A equipped with a solid-state imaging device serves as the second communication device 200A, and a main substrate 602A equipped with control and image processing circuits serves as the first communication device 100A.

In an imaging device (e.g., digital camera), the captured image is disturbed by the hand shake of the operator or vibration of the operator and imaging device together. For example, a single reflex digital camera reflects the image passing through the lens with a main mirror in the shooting preparation stage. The image is formed on a focal plate provided in a pentaprism section at the top of the camera. The user verifies whether the image is in focus. In the next shooting stage, the main mirror retracts from the optical path, allowing the image passing through the lens to be formed on the solid-state imaging device and recorded. That is, the user is unable to directly verify whether the image is in focus on the solid-state imaging device in the shooting stage. As a result, if the position of optical axis of the solid-state imaging device is unstable, the image out of focus would be shot.

As a shake correction mechanism adapted to suppress such a disturbance in the shot image (commonly referred to as a shake correction mechanism), therefore, a mechanism is known that is adapted, for example, to correct the shake by moving the solid-state imaging device. This method is also adopted in the first example and its comparative example.

A shake correction mechanism adapted to correct the shake by moving the solid-state imaging device shifts the solid-state imaging device itself in the plane vertical to the optical axis without driving the lens in the lens barrel. For example, when detecting a shake of its main body, a camera having a shake correction mechanism in the main body moves the solid-state imaging device in the main body according to the shake to ensure that the image formed on the solid-state imaging device remains fixed on the same device. This method corrects the shake by moving the solid-state imaging device in parallel, thus eliminating the need for a dedicated optical system. The solid-state imaging device is lightweight. Therefore, the method is particularly fit for an imaging device in which lenses are replaced.

### Comparative Example

For example, FIG. 12A illustrates a sectional view of an imaging device 500X (camera) as seen from the side (or top or bottom). When an enclosure 590 (device main body) shakes, the focal position of a light beam entering the same device 500X through a lens 592 deviates. Upon detection of the shake, the imaging device 500X adaptively moves a solid-state imaging device 505 (imaging substrate 502X equipped therewith) with shake correction drive sections 510 (e.g., motor or actuator) so as to prevent deviation of the focal position for shake correction. The arrangement of shake correction is a publicly known art, and therefore a detailed description thereof is omitted.

FIG. 12B illustrates a plan view of the imaging substrate 502X. The solid-state imaging device 505 is structured to be moved vertically and horizontally several mm in the figure in the main body integrally with the imaging substrate 502X which is shown hatched. The same device 505 is moved by the shake correction drive sections 510 provided therearound. The imaging substrate 502X equipped with the solid-state imaging device 505 is commonly connected to a main substrate 602X equipped with an image processing engine 605, i.e., a semiconductor device (accommodates control circuits, control signal generating section and image processing circuit and so on) with flexible wires such as flexible printed wiring board (electrical interface 9Z).

In the example shown in FIG. 12B, two flexible printed wiring boards 9X_1 and 9X_2 are used as examples of the electrical interfaces 9Z. The other end of each of the flexible printed wiring boards 9X_1 and 9X_2 is connected to the main substrate 602X having the image processing engine 605 shown in FIG. 12A. An image signal output from the solid-state imaging device 505 is transmitted to the image processing engine 605 via the flexible printed wiring boards 9X_1 and 9X_2.

FIG. 12C illustrates a functional configuration diagram of the signal interfaces between the imaging substrate 502X and main substrate 602X. In this example, an image signal output from the solid-state imaging device 505 is transmitted to the image processing engine 605 as a 12-bit subLVDS (Sub-Low Voltage Differential Signaling) signal.

Further, other low-speed signals such as control signals and synchronizing signal (e.g., serial I/O control signal SIO and clear signal CLR) and power supplied from the power supply sections are also transmitted via flexible printed wiring boards 9X.

However, the following problems arise when the solid-state imaging device 505 travels for shake correction.

i) In addition to the need for downsizing the shake correction mechanism, the electrical interfaces 9Z (electrical wires or cables) adapted to connect the imaging substrate having the solid-state imaging device and the substrate having other circuitry (main substrate) must have some leeway in length to respond to the travel. As a result, a space is required to accommodate the bent electrical interfaces 9Z. Securing such an excess space constitutes a hurdle to downsizing. For example, shape and length constraints of the flexible printed wiring board 9X give rise to limitations on the layout. Further, the connector shape and pin arrangement of the flexible printed wiring board 9X also lead to limitations on the layout.

ii) The electrical interfaces 9Z (e.g., flexible printed wiring boards 9X) are connected at one end to the imaging substrate 502X having the movable solid-state imaging device 505. As a result, the same interfaces 9Z may deteriorate due to mechanical stress.

iii) EMC countermeasures are required because of wired transmission of high-speed signals.

iv) Image signals will be increasingly fast as the solid-state imaging device 505 offers higher definition and frame rate. However, the data rate per wire is limited. As a result, a single wire will not be able to handle such faster image signals. As described earlier, a possible approach to increasing the data rate would be to provide parallel signals by increasing the number of wires so as to reduce the transmission speed of each signal line. However, this remedy leads to problems including more complicated printed circuit boards and cabling and increased physical sizes of the connectors and electrical interfaces 9Z.

### First Example

For this reason, the first example proposes a new arrangement to transmit signals (preferably all signals including power) using a millimeter wave signal as a signal interface between an imaging substrate 502A and a main substrate 602A. A detailed description will be given below.

The first example corresponds, for example, to two cases, one in which the solid-state imaging device 505 is a CCD (Charge Coupled Device) and mounted on the imaging substrate 502A together with its drive section (horizontal and vertical drivers), and another in which the solid-state imaging device 505 is a CMOS (Complementary Metal-Oxide Semiconductor) sensor.

FIGS. 12D to 12U illustrate the arrangements in the first example. These figures are sectional schematic views of an imaging device 500A according to the present embodiment for describing the components mounted on the substrates as with FIG. 12A. These figures focus on the millimeter wave transmission. Therefore, those components not related to the millimeter wave transmission are not illustrated as appropriate. In the description given below, the comparative example shown in FIGS. 12A to 12C should be referred to for the description of the components not illustrated in FIGS. 12D to 12U.

The imaging substrate 502A and main substrate 602A are provided in the enclosure 590 of the imaging device 500A. The main substrate 602A has the first communication device 100 (semiconductor chip 103) to exchange signals with the imaging substrate 502A having the solid-state imaging device 505. The imaging substrate 502A has the second communication device 200 (semiconductor chip 203). As described earlier, the semiconductor chips 103 and 203 include the signal generating sections 107 and 207 and transmission line coupling sections 108 and 208, respectively.

Although not illustrated in some figures, the imaging substrate 502A has the solid-state imaging device 505 and imaging drive section. The shake correction drive sections 510 are provided around the imaging substrate 502A. Although not illustrated in some figures, the main substrate 602A has the image processing engine 605. An operation section and a variety of sensors that are not shown are connected to the main substrate 602A. The main substrate 602A is connectable to peripheral equipment such as personal computer and printer via unshown external interfaces. The operation section includes a power switch, setting dial, jog dial, decision switch, zoom switch and release switch.

The solid-state imaging device 505 and imaging drive section correspond to an application function section of the LSI function section 204 in the wireless transmission systems 1A and 1B. The signal generating section 207 and transmission line coupling section 208 may be accommodated in the semiconductor chip 203 separately from the solid-state imaging device 505. Alternatively, they may be formed integrally with the solid-state imaging device 505 and imaging drive section. If they are provided separately from the solid-state imaging device 505, problems caused by the transmission of signals via electrical wires are likely to occur in the signal transmission therebetween (e.g., between two semiconductor chips). Therefore, the signal generating section 207 and transmission line coupling section 208 should preferably be formed integrally with the solid-state imaging device 505 and imaging drive section. Here, we assume that the signal generating section 207 and transmission line coupling section 208 are accommodated in the semiconductor chip 203 separately from the solid-state imaging device 505 and imaging drive section. A patch antenna may be provided outside the chip as an antenna 236. Alternatively, an inverted F antenna may be formed inside the chip as the same antenna 236.

The image processing engine 605 corresponds to an application function section of the LSI function section 104 in the wireless transmission systems 1A and 1B. An image processing section adapted to process image signals obtained by the solid-state imaging device 505 is accommodated in the same engine 605. The signal generating section 107 and transmission line coupling section 108 may be accommodated in the semiconductor chip 103 separately from the image processing engine 605. Alternatively, they may be formed integrally with the image processing engine 605. If they are provided separately from the same engine 605, problems caused by the transmission of signals via electrical wires are likely to occur in the signal transmission therebetween (e.g., between two semiconductor chips). Therefore, the signal generating section 107 and transmission line coupling section 108 should preferably be formed integrally with the image processing engine 605. Here, we assume that the signal generating section 107 and transmission line coupling section 108 are accommodated in the semiconductor chip 103 separately from the image processing engine 605. A patch antenna may be provided outside the chip as an antenna 136. Alternatively, an inverted F antenna may be formed inside the chip as the same antenna 136.

In addition to the image processing section, a camera control section is accommodated in the image processing engine 605. The camera control section includes a CPU (Central Processing Unit) and storage section (e.g., work memory and program ROM). The camera control section loads the program from the program ROM to work memory to control each section of the imaging device 500A according to the program.

Further, the camera control section controls the imaging device 500A as a whole based on the signals from the switches of the operation section. The same section supplies power to each section by controlling the power supply section and engages in communication with peripheral equipment via external interfaces including transfer of image data.

The camera control section also performs sequence control for shooting. For example, the same section controls the imaging operation of the solid-state imaging device 505 via a synchronizing signal generating section or imaging drive section. The synchronizing signal generating section generates a basic synchronizing signal required for signal processing. The imaging drive section receives the synchronizing signal from the synchronizing signal generating section and the control signals from the camera control section to generate detailed timing signals required to drive the solid-state imaging device 505.

Image signals (imaging signals) sent from the solid-state imaging device 505 to the image processing engine 605 may be analog or digital. When image signals are digital and when the solid-state imaging device 505 is provided separately from an A/D conversion section, the A/D conversion section is mounted on the imaging substrate 502A, regardless of whether the solid-state imaging device 505 is a CCD or CMOS device.

Here, the imaging substrate 502A is arranged to be able to travel vertically and horizontally (up, down, backward and forward in the figures) in response to the shake of the camera main body under the control of the shake correction drive sections 510 for shake correction. On the other hand, the main substrate 602A is fixed to the enclosure 590.

The shake detection is achieved by an unshown shake detection section as this section detects the accelerations of three components or yaw, pitch and roll. The shake detection section includes a gyro sensor. Based on the detection results, the shake correction drive sections 510 cause the solid-state imaging device 505 to swing in the plane vertical to the optical path using motors or actuators, thus correcting the shake. The shake detection section and shake correction drive sections 510 make up the shake correction section adapted to correct the shake.

The imaging substrate 502A has the signal generating section 207 and transmission line coupling section 208 in addition to the solid-state imaging device 505 to provide the wireless transmission systems 1A and 1B. Similarly, the main substrate 602A has the signal generating section 107 and transmission line coupling section 108 to provide the wireless transmission systems 1A and 1B. The transmission line coupling section 208 of the imaging substrate 502A is coupled to the transmission line coupling section 108 of the main substrate 602A by the millimeter wave signal transmission line 9. This permits bidirectional transmission in the millimeter wave band between the transmission line coupling section 208 of the imaging substrate 502A and the transmission line coupling section 108 of the main substrate 602A.

It should be noted that the main substrate 602A further has a power supply section to provide the wireless transmission system 1D according to the fourth embodiment, operable to transmit power wirelessly as well. Similarly, the imaging substrate 502A further has a power reception section to provide the wireless transmission system 1D according to the fourth embodiment.

If unidirectional transmission is acceptable, it is only necessary to arrange the transmitting-side signal generating sections 110 and 210 at the transmitting side and the receiving-side signal generating sections 120 and 220 at the receiving side, thus coupling the transmitting and receiving sides using the transmission line coupling sections 108 and 208 and millimeter wave signal transmission line 9. For example, if only imaging signals obtained by the solid-state imaging device 505 are transmitted, it is only necessary to use the imaging substrate 502A as a transmitting side and the main substrate 602A as a receiving side. If only the signals adapted to control the solid-state imaging device 505 (e.g., master clock signal, control signals and synchronizing signal) are transmitted, it is only necessary to use the main substrate 602A as a transmitting side and the imaging substrate 502A as a receiving side.

Millimeter wave communication between the two antennas 136 and 236 permits transmission of image signals obtained by the solid-state imaging device 505 to the main substrate 602A using a millimeter wave signal via the millimeter wave signal transmission line 9 between the antennas 136 and 236. Further, a variety of control signals adapted to control the solid-state imaging device 505 are transmitted to the imaging substrate 502A using a millimeter wave signal via the millimeter wave signal transmission line 9 between the antennas 136 and 236. Still further, in the case of the configuration adapted to provide the wireless transmission system 1D, power to be supplied to the solid-state imaging device 505 and imaging drive section is transmitted to the imaging substrate 502A in a manner different from the millimeter wave transmission via the millimeter wave signal transmission line 9.

The millimeter wave signal transmission line 9 may be provided in one of two different manners, one in which the antennas 136 and 236 are arranged opposed to each other (FIGS. 12D to 12I), and another in which the antennas 136 and 236 are arranged out of line with each other in the direction of the plane of the substrates (FIGS. 12J to 12M).

When the antennas 136 and 236 are arranged opposed to each other (FIGS. 12D to 12I), the following two configurations are possible. Firstly, the main substrate 602A having the antenna 136 is located more backward than the imaging substrate 502A (on the side opposite to a lens 592) (FIGS. 12D to 12G). Secondly, two main substrates 602A_1 and 602A_2 are used rather than the single main substrate 602A. The main substrate 602A_1 has the image processing engine 605, and the main substrate 602A_2 has the antenna 136. The main substrate 602A_2 having the antenna 136 is located forward (on the side of the lens 592) (FIG. 12H). In the first configuration, the imaging substrate 502A engages in millimeter wave communication in the direction away from the lens 592. In the second configuration, on the other hand, the imaging substrate 502A engages in millimeter wave communication in the direction toward the lens 592. The imaging substrate 502A is commonly located in the back of the may body of an imaging device 500 (on the side opposite to the lens 592). In some cases, therefore, the second configuration allows for a communication space to be secured with more ease.

When the antennas 136 and 236 are opposed to each other, patch antennas as shown in FIG. 12I should be used that are directional in the direction of the normal to the substrates. Although directional in the direction of the normal, a patch antenna is not significantly directional. Therefore, so long as the antennas 136 and 236 overlap over an area that is to some extent large, their reception sensitivity will not be adversely affected even if they are somewhat out of line with each other. When the solid-state imaging device 505 travels two-dimensionally in the direction of the plane of the imaging substrate 502A for shake correction, the antenna 236 (located on the imaging substrate 502A) which is the counterpart of the antenna 136 travels within a given range in the plane of the substrate. However, the variations in reception level can be kept at a given level.

In millimeter wave communication, the antennas used are small or of the order of several mm square, making them easy to install in tight areas such as inside the imaging device 500. When patch antennas are used, the length of one side is given by λg/2 where the wavelength in the substrate is λg. For example, when a 60 GHz millimeter wave is used for the substrates 502A and 602A having a specific dielectric constant of 3.5, λg is 2.7 mm or so. As a result, one side of the patch antenna is about 1.4 mm.

When the antennas 136 and 236 are arranged out of line with each other in the direction of the plane of the substrates, millimeter wave communication is conducted horizontally relative to the substrates 502A and 602A. This configuration provides a reduced gap between the imaging substrate 502A and main substrate 602A as compared to the configuration in which the antennas are opposed to each other.

Incidentally, in this case, dipole antennas as illustrated in FIG. 12M should be used that are directional in the direction of the plane of the substrates. A dipole antenna is directional in the direction of the tangent (direction of the arrow in the figure). Therefore, when dipole antennas are used in the configuration in which the antennas 136 and 236 are out of line with each other in the direction of the plane of the substrates, the two antennas can be installed in the directional direction. Among types of directional antennas other than dipole antenna are a Yagi-Uda antenna and inverted F antenna. A Yagi-Uda antenna is made up of a waveguide or reflecting element arranged adjacent to a dipole antenna.

The millimeter wave signal transmission line 9 may be not only the free space transmission line 9B as illustrated in FIGS. 12D and 12J but also a dielectric transmission line 9A as illustrated in FIGS. 12E, 12F, 12K and 12L and a hollow waveguide 9L as illustrated in FIG. 12G.

As an example of using the dielectric transmission line 9A as the millimeter wave signal transmission line 9, a soft (flexible) dielectric material such as silicone resin-based material may be used for connection between the antennas 136 and 236 as illustrated in FIGS. 12E and 12K. The dielectric transmission line 9A may be surrounded by a shielding material (e.g., conductor). In order to take advantage of the flexibility of the dielectric material, the shielding material should also be flexible. Although a connection is made by the dielectric transmission line 9A, the same line 9A can be routed as with electrical wires thanks to the softness of the material. In addition, the solid-state imaging device 505 (imaging substrate 502A) is not restricted in its travel.

As another example of using the dielectric transmission line 9A, the same line 9A may be fixed to the antenna 136 that is provided on the main substrate 602A as illustrated in FIGS. 12F and 12L so that the antenna 236 on the imaging substrate 502A travels by sliding over the dielectric transmission line 9A. In this case, the dielectric transmission line 9A may be also surrounded by a shielding material (e.g., conductor). The solid-state imaging device 505 (imaging substrate 502A) is not restricted in its travel if friction is reduced between the antenna 236 on the imaging substrate 502A and the dielectric transmission line 9A. Conversely, the dielectric transmission line 9A may be fixed to the imaging substrate 502A. In this case, the antenna 136 of the main substrate 602A travels by sliding over the dielectric transmission line 9A.

The hollow waveguide 9L need only be surrounded by a shielding material and hollow inside. As illustrated in FIG. 12G, for example, the hollow waveguide 9L is surrounded by a conductor MZ, an example of a shielding material, and hollow inside. For example, a covering made of the conductor MZ is attached in such a manner to surround the antenna 136 on the main substrate 602A. The center of travel of the antenna 236 on the imaging substrate 502A is arranged to be opposed to the antenna 136. Because the conductor MZ is hollow inside, there is no need to use any dielectric material, thus making it possible to form the millimeter wave signal transmission line 9 at low cost and with ease.

As illustrated in FIGS. 12N and 12O, the covering made of the conductor MZ may be provided either on the main substrate 602A or imaging substrate 502A. In either case, a distance L between the covering made of the conductor MZ and the imaging substrate 502A or main substrate 602A (length of the gap from the end of the conductor MZ to the substrate facing the conductor MZ) should be sufficiently smaller than the wavelength of the millimeter wave. However, the distance L should be set in such a manner as not to interfere with the travel of the imaging substrate 502A (imaging device 505).

The size and shape of the shielding material (covering: conductor MZ) should be determined in consideration of the travel range of the imaging substrate 502A. That is, the shielding material need only be sized and shaped in plan view so that the antenna 236 on the imaging substrate 502A does not move out of the covering (conductor MZ) or range within which the antennas 136 and 236 are opposed to each other when the imaging substrate 502A travels. So long as this requirement is met, the shape of the conductor MZ in plan view may be circular, triangular, rectangular or any other desired shape.

For example, FIG. 12P illustrates a case in which the covering provided on the main substrate 602A has a rectangular cross section. In this case, letting both the vertical and horizontal movable ranges of the imaging substrate 502A be denoted by ±m and one side of the antenna 236 by a, a length w of one side of the covering is w≧(2m+a).

FIG. 12Q illustrates a case in which the covering provided on the main substrate 602A has a circular cross section. In this case, letting both the vertical and horizontal movable ranges of the imaging substrate 502A be denoted by ±m and one side of the antenna 236 by a, a diameter r of the covering is r≧(2m+a)·√2.

The hollow waveguide 9L may be formed not only by forming a covering with the conductor MZ on one of the substrates but also by forming a hole in a relatively thick substrate (hole may or may not be a penetrating hole) so that the wall of the hole is used as a covering as illustrated in FIGS. 12R to 12U. In this case, the substrate serves as a shielding material. A hole may be formed in either or both of the imaging substrate 502A and main substrate 602A. The side wall of the hole may or may not be covered with a conductor. In the latter case, the millimeter wave will be reflected and intensely distributed in the hole because of the specific dielectric constant ratio between the substrate and air. When the hole is a penetrating hole, the antenna 136 or 236 need only be arranged (attached) on (to) the rear side of the semiconductor chip 103 or 203. When the hole is a non-penetrating hole, the antenna 136 or 236 need only be arranged on the bottom of the hole.

The cross-sectional shape of each hole may be circular, triangular, rectangular or in any other desired shape. When the hole is rectangular, the length of one side thereof is as per W in FIG. 12P. When the hole is circular, the diameter thereof is as per r in FIG. 12Q.

For example, FIG. 12R illustrates a case in which a penetrating hole is formed in the main substrate 602A. The antenna 136 on the main substrate 602A is attached to the rear side of the semiconductor chip 103. FIG. 12S illustrates a case in which a non-penetrating hole is formed on the main substrate 602A, with the antenna 136 provided on the bottom of the hole. FIG. 12T illustrates a case in which a penetrating hole is formed in the imaging substrate 502A. The antenna 236 on the imaging substrate 502A is attached to the rear side of the semiconductor chip 203. Although not illustrated, a non-penetrating hole may be formed in the imaging substrate 502A so that the antenna 236 is provided on the bottom of the hole.

FIG. 12U illustrates a case in which a penetrating hole is formed in the main substrate 602A so that the antenna 136 is attached to the rear side of the semiconductor chip 103 and a penetrating hole is formed in the imaging substrate 502A so that the antenna 236 is attached to the rear side of the semiconductor chip 203. Although not illustrated, (either or both of) the holes in the imaging substrate 502A and main substrate 602A may be non-penetrating holes. In this case, either or both of the antennas 136 and 236 need only be provided on the bottoms of the holes.

The dielectric transmission line 9A and hollow waveguide 9L trap the millimeter wave therein thanks to their covering, thus providing a variety of advantages. Such advantages include low loss in transmission of the millimeter wave, efficient transmission, minimal external radiation of the millimeter wave and ease of providing EMC countermeasures.

In the first example, image signals obtained by the solid-state imaging device 505 are transmitted to the main substrate 602A and transferred to the image processing engine 605 in the form of millimeter wave modulated signals. The control signals adapted to operate the solid-state imaging device 505 are also transmitted to the imaging substrate 502A in the form of millimeter wave modulated signals. Further, power adapted to operate the different sections of the imaging substrate 502A can also be supplied wirelessly by means of an arrangement different from that for the millimeter wave transmission.

This offers the following advantages over the case of using the electrical interfaces 9Z (flexible printed wiring boards 9X).

i) There is no need to use cables for transmission between the substrates for those signals that are converted into a millimeter wave signal before transmission. For those signals to be transmitted in the form of a millimeter wave signal, the wireless transmission eliminates the likelihood of deterioration of wires caused by mechanical stress as when the electrical interfaces 9Z are used. Thanks to the reduced number of electrical wires, the cable space can be reduced. Further, means adapted to move the solid-state imaging device 505 (imaging substrate 502A equipped therewith) can be less loaded, thus providing the imaging device 500 having a small-size shake correction mechanism with low power consumption.

ii) Wireless transmission of power using the resonance method relying on the resonance in a magnetic field allows for wireless transmission of all signals including power without adversely affecting the millimeter wave transmission, thus eliminating the need to adhere to connections using cables and connectors. This completely clears the problem of wire deterioration caused by mechanical stress as when the electrical interfaces 9Z are used.

iii) Thanks to wireless transmission, there is no need to be concerned about the wire shape and connector positions. As a result, there are not many limitations on the layout.

iv) The millimeter wave band has a short wavelength with large distance attenuation and small diffraction, making it easy to achieve electromagnetic shielding.

v) Wireless transmission using a millimeter wave signal and transmission within a dielectric waveguide eliminates the need for EMC countermeasures that are required for the electrical interfaces 9Z (flexible printed wiring boards 9X). Further, there are commonly no other devices in the camera that use frequencies in the millimeter wave band. As a result, EMC countermeasures are easy to achieve even if such countermeasures are necessary.

vi) A wide communication band can be secured in millimeter wave transmission, making it easy to deliver a high data rate. Wireless transmission using a millimeter wave signal and transmission within a dielectric waveguide provides a significantly higher data rate than when the electrical interfaces 9Z are used, making it easy to handle increasingly fast image signals resulting from higher definition and higher frame rate of the solid-state imaging device 505.

It should be noted that Patent Document 2 discloses an arrangement adapted to wirelessly transmit signals between the substrates in the imaging device 500 capable of shake correction similar to that described in the present example. However, the arrangement described in Patent Document 2 differs from that described in the first example in the following respects.

a) The optical communication disclosed in Patent Document 2 uses an infrared LED or infrared semiconductor laser. However, an infrared LED is narrow in bandwidth, making it unfit for high-speed communication. On the other hand, an infrared semiconductor laser requires high positioning accuracy. If a light reception element with a large light reception range is used, the same element must be large. However, such a large light reception element is slow and requires a lens, resulting in higher cost and layout constraints. If a plurality of light reception elements are provided, this will lead to higher cost and layout constraints. If the imaging element is fixed at a predetermined position before communication following the shooting, this operation must be controlled, thus resulting in time constraints. In contrast, it can be understood from the description given earlier that the arrangement in the first example has none of these problems.

b) Both infrared LED and infrared semiconductor laser are generally GaAs-based devices. Neither of these devices can be integrated into a single chip with silicon (Si)-based CMOS circuitry, thus resulting in high cost. In contrast, the arrangement adapted to achieve transmission using a millimeter wave signal as in the first example allows for formation of the transmission circuitry and antennas on a silicon (Si) surface and integration thereof into a single chip together with other CMOS circuitry, thus achieving downsizing and lower cost.

c) Communication using electromagnetic wave disclosed in Patent Document 2 uses, as an example, the IEEE802.11a/b/g technology. However, the IEEE802.11a/b/g technology employs the 2.4 GHz and 5 GHz bands. As a result, the carrier frequencies are unfit for low-speed communication. Besides, the antennas are large, making them problematic in packaging. Further, in order to reduce driving-related noise, communication must be performed after stopping the shake correction operation.

In contrast, it can be understood that the arrangement in the first example has none of these problems. For example, the millimeter wave has a high frequency, making it immune to noise and allowing for communication concurrently with the shake correction operation. Naturally, communication may be performed after stopping the shake correction operation. In this case, thanks to high speed of millimeter wave transmission, signals can be transmitted in a short time, thus contributing to a shorter stopping time.

### <Millimeter Wave Transmission Structure: Second Example>

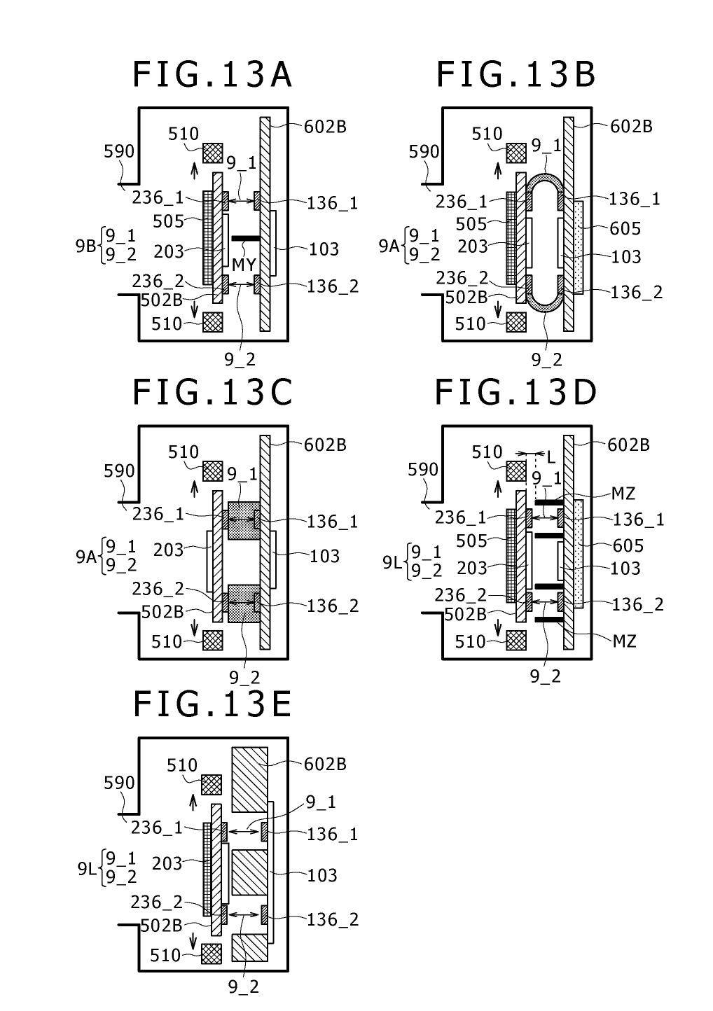

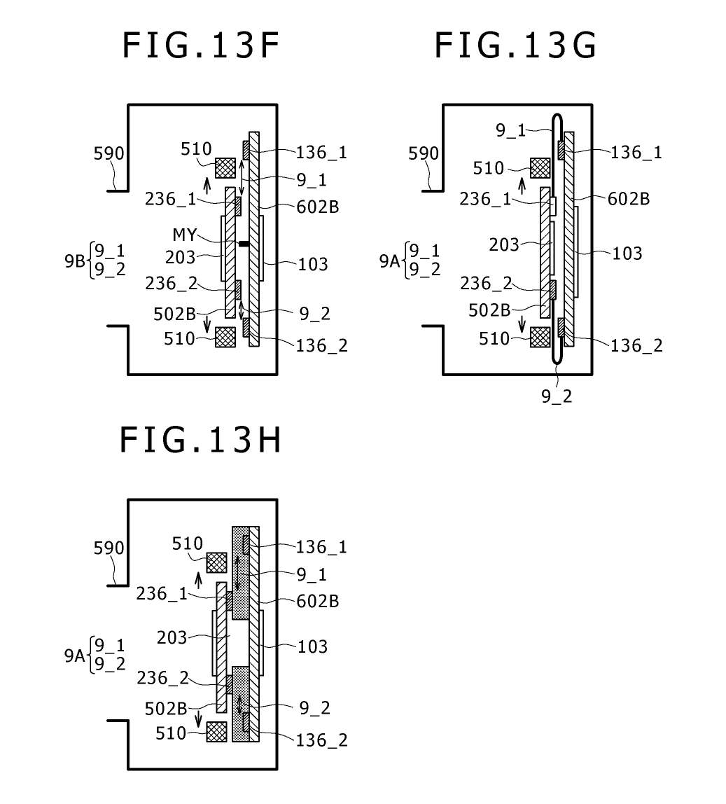

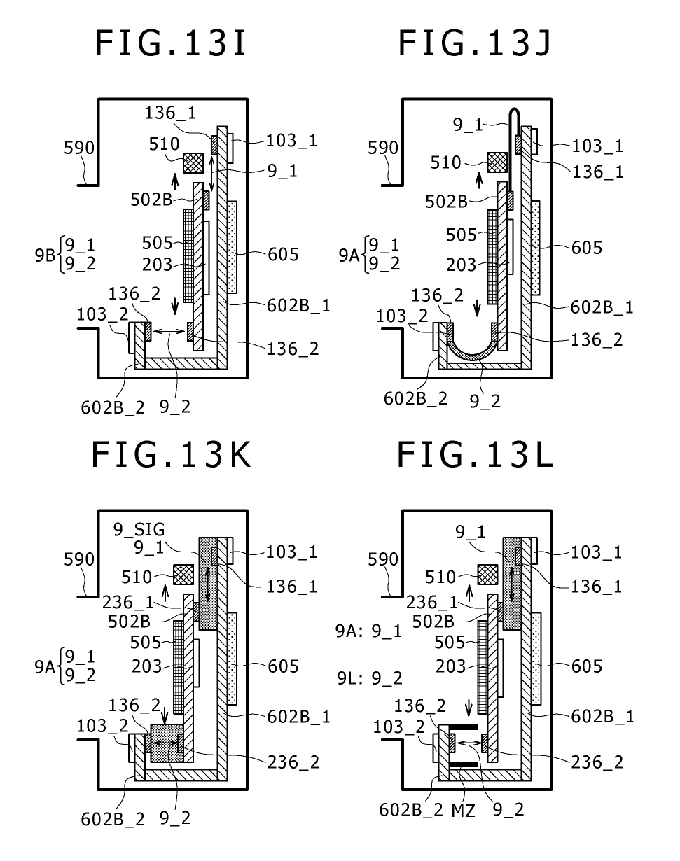

FIGS. 13A to 13L are diagrams describing a second example of a millimeter wave transmission structure according to the present embodiment. As with the first example, the second example is an example of application to an imaging device capable of shake correction by moving its solid-state imaging device. The second example is an application example of a millimeter wave transmission structure for achieving the functions of the wireless transmission systems 1C and 1E according to the third and fifth embodiments. A description will be given below with primary emphasis on the differences from the first example.

An imaging substrate 502B has the signal generating section 207 and transmission line coupling section 208 in addition to the solid-state imaging device 505 to provide the wireless transmission system 1C. Similarly, a main substrate 602B has the signal generating section 107 and transmission line coupling section 108 to provide the wireless transmission system 1C according to the third embodiment. The transmission line coupling sections 108 and 208 are coupled by the millimeter wave signal transmission line 9. This provides two separate millimeter wave signal transmission lines 9_1 and 9_2, the former for signal transmission from the imaging substrate 502B to the main substrate 602B and the latter for signal transmission from the main substrate 602B to the imaging substrate 502B. Bidirectional signal transmission in the millimeter wave band takes place between the transmission line coupling sections 108 and 208.

It should be noted that, in order to provide the wireless transmission system 1E according to the fifth embodiment operable to transmit power as well, the main substrate 602B further has a power supply section. Similarly, the imaging substrate 502B further has a power reception section to provide the wireless transmission system 1E according to the fifth embodiment.

The millimeter wave communication between the two antennas 136 and 236 permits transmission of the image signal obtained by the solid-state imaging device 505 to the main substrate 602B using a millimeter wave signal via the millimeter wave signal transmission lines 9 between the antennas 136 and 236. Further, a variety of control signals adapted to control the solid-state imaging device 505 are transmitted to the imaging substrate 502B using a millimeter wave signal via the millimeter wave signal transmission lines 9 between the antennas 136 and 236. Still further, in the case of the configuration adapted to provide the wireless transmission system 1E, power to be supplied to the solid-state imaging device 505 and imaging drive section is transmitted wirelessly to the imaging substrate 502B via the power supply and reception sections.

The millimeter wave signal transmission lines 9 may be provided in one of three different manners, one in which the antennas 136 and 236 are arranged opposed to each other (FIGS. 13A to 13E), another in which the antennas 136 and 236 are arranged out of line with each other in the direction of the plane of the substrates (FIGS. 13F to 13H), and still another which is a combination of the above two configurations (FIGS. 13I to 13L). When the antennas 136 and 236 are arranged opposed to each other, antennas such as patch antennas should be used that are directional in the direction of the normal to the substrates. When the antennas 136 and 236 are arranged out of line with each other in the direction of the plane of the substrates, antennas such as dipole antennas, Yagi-Uda antennas or inverted F antennas should be used that are directional in the direction of the plane of the substrates.

Each of the millimeter wave signal transmission lines 9 may be not only the free space transmission line 9B as illustrated in FIGS. 13A, 13F and 13I but also the dielectric transmission line 9A as illustrated in FIGS. 13B, 13C, 13G, 13H, 13J and 13K and the hollow waveguide 9L as illustrated in FIGS. 13D and 13L.

When the free space transmission line 9B is used as the millimeter wave signal transmission line 9 with the plurality of same lines 9 provided close to each other, a structure (millimeter wave shielding material MY) should preferably be provided to hinder radio wave propagation so as to suppress interference between the antennas of the millimeter wave signal transmission lines 9. The millimeter wave shielding material MY may be provided on either or both of the main substrate 602B and imaging substrate 502B. Whether to provide the millimeter wave shielding material MY need only be determined based on the spatial distance and degree of interference between the millimeter wave signal transmission lines 9. The degree of interference is also related to the transmitted power. Whether to provide the millimeter wave shielding material MY is determined in comprehensive consideration of the spatial distance, transmitted power and degree of interference.

As an example of using the dielectric transmission line 9A as the millimeter wave signal transmission line 9, a soft (flexible) dielectric material such as silicone resin-based material may be used for connection between each pair of the antennas 136 and 236 as illustrated in FIGS. 13B, 13G and 13J. As another example thereof, each of the dielectric transmission lines 9A may be fixed to each of the antennas 136 provided on one of the main substrates 602B as illustrated in FIGS. 13C, 13H and 13K so that each of the antennas 236 on the imaging substrate 502B travels by sliding over one of the dielectric transmission lines 9A. Conversely, each of the dielectric transmission lines 9A may be fixed to the imaging substrate 502B. In this case, each of the antennas 136 on one of the main substrates 602B travels by sliding over one of the dielectric transmission lines 9A. These dielectric transmission lines 9A can be used in the same manner as in the first example.

The hollow waveguide 9L need only be surrounded by a shielding material and hollow inside. As illustrated in FIGS. 13D and 13L, for example, the hollow waveguide 9L is surrounded by the conductor MZ, an example of a shielding material, and hollow inside. Further, the hollow waveguide 9L may be formed by forming a penetrating or non-penetrating hole in a relatively thick substrate (hole may or may not be a penetrating hole) so that the wall of the hole is used as a covering as illustrated in FIG. 13E in the same manner as done in FIGS. 12R to 12U. The hollow waveguides 9L can be used in the same manner as in the first example.

In the second example, image signals obtained by the solid-state imaging device 505 are also transmitted to the main substrates 602B and transferred to the image processing engine 605 in the form of millimeter wave modulated signals. The control signals adapted to operate the solid-state imaging device 505 are also transmitted to the imaging substrate 502B in the form of millimeter wave modulated signals. Further, power adapted to operate the different sections of the imaging substrate 502B can also be supplied wirelessly by means of an arrangement different from that for the millimeter wave transmission.

In particular, the functional configurations of the wireless transmission systems 1C and 1E according to the third and fifth embodiments are used in the second example. Therefore, space division multiplexing allows for concurrent use of the same frequency band, thus providing higher transmission speed. Moreover, the simultaneity of bidirectional communication can be guaranteed in which bidirectional signal transmission takes place concurrently. The plurality of millimeter wave signal transmission lines 9 permit full duplex transmission, contributing to improved data exchange efficiency. Further, using a plurality of transmission channels in the same direction provides higher transmission speed.

In the figures, for example, one of the millimeter wave signal transmission lines 9 may be used to transmit an imaging signal from the imaging substrate 502B to the main substrate 602B and another to transmit an imaging signal from the main substrate 602B to the imaging substrate 502B. Providing the two millimeter wave signal transmission lines 9 allows for bidirectional communication.

The present application contains subject matter related to that disclosed in Japanese Priority Patent Application JP 2009-187710 filed in the Japan Patent Office on Aug. 13, 2009, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. An imaging device comprising:
a first substrate having a first communication device;
a second substrate having a solid-state imaging device and second communication device to exchange signals with the first substrate;
a shake correction section adapted to detect the shake of an enclosure and correct the shake based on the detection result by moving the first substrate in the plane vertical to the optical path; and
a millimeter wave signal transmission line that permits transmission of information in the millimeter wave band between the first and second communication devices, wherein
a signal to be transmitted between the first and second communication devices is converted into a millimeter wave signal first before being transmitted via the millimeter wave signal transmission line.

2. The imaging device of claim 1, wherein
the millimeter wave signal transmission line is structured to transmit a millimeter wave signal while trapping the signal in the transmission line.

3. The imaging device of claim 2, wherein
the millimeter wave signal transmission line is a dielectric transmission line made of a dielectric material capable of millimeter wave signal transmission.

4. The imaging device of claim 3, wherein
a dielectric material is provided around the shielding material to suppress external radiation of a millimeter wave signal.

5. The imaging device of claim 2, wherein
the millimeter wave signal transmission line is a hollow waveguide in which the transmission line is made up of and surrounded by a hollow shielding material adapted to suppress external radiation of the millimeter wave signal.

6. The imaging device of claim 1, wherein
the first substrate has an image processing section adapted to process an imaging signal obtained by the solid-state imaging device mounted on the second substrate, and
the imaging signal obtained by the solid-state imaging device is converted into a millimeter wave signal first as the signal to be transmitted between the first and second communication devices before being transmitted via the millimeter wave signal transmission line.

7. The imaging device of claim 1, wherein
the first substrate has a control signal generating section adapted to generate signals that are used to control the solid-state imaging device mounted on the second substrate, and
each of the signals used to control the solid-state imaging device is converted into a millimeter wave signal first as the signal to be transmitted between the first and second communication devices before being transmitted via the millimeter wave signal transmission line.

8. The imaging device of claim 1, wherein
the first substrate has a power supply section adapted to wirelessly supply power to be consumed by the second substrate, and
the second substrate has a power reception section adapted to wirelessly receive power from the first substrate.

9. The imaging device of claim 8, wherein
power is transmitted from the power supply section to the power reception section by taking advantage of resonance in a magnetic field.

10. The imaging device of claim 1, wherein
each of the first and second communication devices has a switching section adapted to switch between transmission and reception timings in a time-divided manner, and
the first and second communication devices perform half duplex bidirectional transmission using the single millimeter wave signal transmission line.

11. The imaging device of claim 1, wherein
the first and second communication devices use millimeter wave signals at different frequencies for transmission and reception to perform full duplex bidirectional transmission using the single millimeter wave signal transmission line.

12. The imaging device of any one of claims 1 to 9, wherein
the first and second communication devices use a millimeter wave signal at the same frequency for transmission and reception and use the different millimeter wave signal transmission lines for transmission and reception to perform full duplex bidirectional transmission.

13. The imaging device of claim 1, wherein
each of the first and second communication devices has, in its portion serving as a transmitting side, a multiplexing process section adapted to combine a plurality of signals to be transmitted into a single signal by time division multiplexing, and
each of the first and second communication devices has, in its portion serving as a receiving side, a uniplexing process section adapted to divide the single millimeter wave signal received via the millimeter wave signal transmission line back into the different millimeter wave signals.

14. The imaging device of claim 1, wherein
each of the first and second communication devices has, in its portion serving as a transmitting side, a multiplexing process section adapted to convert a plurality of signals to be transmitted into millimeter wave signals at different frequencies for transmission via the single millimeter wave signal transmission line, and
each of the first and second communication devices has, in its portion serving as a receiving side, a uniplexing process section adapted to divide the single millimeter wave signal received via the millimeter wave signal transmission line back into the different millimeter wave signals.

15. The imaging device of claim 1, wherein
the first and second communication devices use a millimeter wave signal at the same frequency for a plurality of signals to be transmitted and transmit the plurality of signals using the different millimeter wave signal transmission lines.
